(19) United States
(12) Patent Application Publication
(10) Pub. No.: US 2026/0296033 A1
(43) Pub. Date: Oct. 1, 2026

(54) METHOD AND APPARATUS FOR EJECTING FLUIDS

(71) Applicant: ARCHIPELAGO TECHNOLOGY GROUP LTD., Cambridge (GB)

(72) Inventors: Benjamin Alexander David BREBNER, Cambridge (GB); Daniel Richard MACE, Cambridge (GB); Khaled Hamood Abdullah AL-GHAITHI, Cambridge (GB); Guy Charles Fernley NEWCOMBE, Cambridge (GB)

(73) Assignee: ARCHIPELAGO TECHNOLOGY GROUP LTD., Cambridge (GB)

(21) Appl. No.: 19/479,426

(22) PCT Filed: Apr. 26, 2024
(86) PCT No.: PCT/EP2024/061619

§ 371 Date: Oct. 28, 2025

(30) Foreign Application Priority Data
Apr. 28, 2023 (GB) 2306378.7

(51) Int. Cl. B41J 2/17; B41J 2/14; B41J 2/165; B41J 2/175

(52) U.S. Cl. CPC B41J 2/1707; B41J 2/1433; B41J 2/16552; B41J 2/175; B41J 2202/02; B41J 2202/03

(57) ABSTRACT

A fluid ejector for ejecting discrete volumes of ejectant. The fluid ejector comprises a body and at least one nozzle defined between first and second surfaces of the body. The fluid ejector further comprises a barrier fluid supplier for supplying barrier fluid to each of one or more nozzles of the at least one nozzle, an ejectant supplier for supplying ejectant to each of the one or more nozzles, and an ejector for imparting an ejection force to ejectant contained within each of the one or more nozzles. In use, the fluid ejector performs a barrier fluid supply step in which the barrier fluid supplier supplies the barrier fluid to each of the one or more nozzles, then an ejectant supply step in which the ejectant supplier supplies ejectant to each of the one or more nozzles; and then an ejection step in which the ejector imparts an ejection force to the ejectant contained within each of the one or more nozzles to cause ejection of at least some of the ejectant from each of the one or more nozzles. The barrier fluid at least partially coats an interior surface of each of the one or more nozzles to reduce contact of the ejectant with the interior surface of each of the one or more nozzles.

### TECHNICAL FIELD

The present disclosure relates to apparatuses and methods for dispensing flowable materials, such as liquids, and in particular to fluid ejectors and related methods that enable dispensing of a discrete quantity of fluids.

### BACKGROUND

Fluid ejectors (which may also be referred to as fluid “dispensers”) are commonly adapted to eject (dispense) flowable materials (i.e., materials whose constituent parts or sub-volumes are capable of relative motion, such as ink or glue) through one or more nozzles of the fluid ejector. Ejectants include liquid suspensions, solutions, emulsions, waxes, gels, and the like and are usually ejected in the form of droplets (i.e. volumes of liquid bounded, completely or almost completely, by free surface).

WO 2017/141034 A1, in the name of Archipelago Technology Group Ltd (“Archipelago”) discloses a recently developed type of fluid ejector for ejecting discrete, and typically metered, volumes of ejectant. Archipelago's fluid ejectors, which are consistent with WO 2017/141034 A1 and are referred to in the industry as “Powerdrop®”, comprise a rigid body through which one or more patterns of nozzles is formed. The nozzles are filled with ejectant by an ejectant supply assembly from one side of the body, for example by moving the body relative to the supply assembly to expose the nozzles to the ejectant supply assembly. The ejectant is then ejected from the nozzles by pressurised gas supplied to the nozzles from a gas supply assembly, typically incorporating a gas supply head. In some embodiments, the rigid nozzle-bearing body of the Powerdrop® fluid ejectors takes the form of an annular drum or roller, which rotates to successively expose the nozzles to the ejectant supply assembly and the gas supply assembly to allow filling of the nozzles with ejectant and ejection of the ejectant from the nozzles. Continuous rotation of the drum allows the Powerdrop® apparatus to apply either a pattern or a continuous coating of ejectant to a substrate that moves relative to the drum, for example on a conveyor system.

Archipelago's Powerdrop® system provides a number of notable advantages over previous fluid ejectors, such as conventional inkjet systems. For example, the Powerdrop® system advantageously enables the dispensing of discrete, metered quantities of fluids in a manner that is tolerant of varying operating conditions of practical industrial applications. Furthermore, the Powerdrop® fluid ejectors extend the practical applications of ejection of discrete quantities of ejectants to a wider range of ejectants, a wider range of ejection rates, and a wider range of volumes of ejected ejectant than those known in the ink-jet art. By using a supply of pressurised gas greater ejection energies can be provided than is provided by known ink-jet actuation means. Such use of pressurised gas also provides physical displacements of the ejectant that are larger than those provided by known ink-jet actuation means, thereby advantageously increasing the largest ejectant volume that can be ejected.

However, despite these notable advantages over existing technologies, when operated for extended periods of time and with some types of ejectant the nozzles of Powerdrop® fluid ejectors may experience some degree of build-up of small amounts of ejectant residue. This is most often experienced when the ejectant dries, cures, sets or spoils, for example, to leave a residue, for example via evaporation of a carrier component of the ejectant. For example, when water-based glues such as polyvinyl acetate (PVA) glues are ejected using such systems over an extended period of time the glue can dry through evaporation of the water carrier component to leave a PVA residue in the nozzles. Similarly, ejectant that is applied to the surface of the nozzle-bearing body during the ejectant loading step may also dry, cure, set or spoil to leave a residue on the surface of the drum. This build-up of residue limits the maximum amount of time the fluid ejector may be operated for before maintenance is required, for example to clean the drum of residue or exchange the drum with a residue-free drum.

The present disclosure therefore, amongst other advantages, provides nozzle-based fluid ejectors that reduce the build-up of ejectant residue over time, thereby increasing the length of operational periods between maintenance during which the fluid ejector performs as required.

### SUMMARY

According to a first aspect of the disclosure, there is provided a method for ejecting discrete volumes of ejectant. The method comprises supplying barrier fluid to each of one or more nozzles via a supply orifice of each of the one or more nozzles. Each of the one or more nozzles is formed in a body and is defined by a conduit extending through the body to connect a first orifice of the nozzle formed in a first surface of the body and a second orifice of the nozzle formed in a second surface of the body opposed to the first surface, and wherein the supply orifice is the first orifice or the second orifice of the nozzle. The method then comprises supplying ejectant to each of the one or more nozzles via the second orifice of each of the one or more nozzles. The method then comprises ejecting at least some of the ejectant from each of the one or more nozzles via the second orifice of each of the one or more nozzles. The barrier fluid may at least partially coat an interior surface of each of the one or more nozzles to reduce contact of the ejectant with the interior surface of each of the one or more nozzles.

In some embodiments, ejecting at least some of the ejectant from each of the one or more nozzles via the second orifice of each of the one or more nozzles comprises ejecting at least some of the barrier fluid from each of the one or more nozzles via the second orifice of each of the one or more nozzles.

In some embodiments, the barrier fluid at least partially coats the interior surface of each of the one or more nozzles to reduce adhesion of the ejectant to the interior surface of each of the one or more nozzles.

In some embodiments, the barrier fluid at least partially coats the interior surface of each of the one or more nozzles, thereby lubricating the interface between the ejectant and the interior surface of the one or more nozzles to facilitate ejection of the ejectant from the one or more nozzles.

In some embodiments, supplying the barrier fluid to each of the one or more nozzles comprises moving the body relative to a barrier fluid supplier to expose the supply orifice of each of the one or more nozzles formed in the body to a barrier fluid supplier to supply the barrier fluid to each of the one or more nozzles via the supply orifice of each of the one or more nozzles.

In some embodiments, supplying the ejectant to each of the one or more nozzles via the second orifice of each of the one or more nozzles comprises moving the body relative to an ejectant supplier to expose the second orifice of each of the one or more nozzles to the ejectant supplier to supply the ejectant to each of the one or more nozzles via the second orifice of each of the one or more nozzles.

In some embodiments, ejecting at least some of the ejectant from each of the one or more nozzles via the second orifice of each of the one or more nozzles comprises supplying pressurised gas to each of the one or more nozzles via the first orifice of each of the one or more nozzles to cause ejection of the at least some of the ejectant from each of the one or more nozzles via the second orifice of each of the one or more nozzles.

In some embodiments, ejecting at least some of the ejectant from each of the one or more nozzles via the second orifice of each of the one or more nozzles comprises exposing the first orifice of each of the one or more nozzles to a gas supplier to supply the pressurised gas to each of the one or more nozzles via the first orifice of each of the one or more nozzles to cause ejection of the at least some of the ejectant from each of the one or more nozzles via the second orifice of each of the one or more nozzles.

In some embodiments, exposing the first orifice of each of the one or more nozzles to the gas supplier comprises moving the body relative to the gas supplier to expose the first orifice of each of the one or more nozzles to the gas supplier.

In some embodiments, the at least some of the ejectant is ejected from each of the one or more nozzles via the second orifice of each of the one or more nozzles onto a substrate.

In some embodiments, the method further comprises continuously repeating the supplying the barrier fluid, the supplying the ejectant, and the ejecting at least some of the ejectant steps. In some embodiments the method further comprises continuously repeating the supplying the barrier fluid, the supplying the ejectant, and the ejecting at least some of the ejectant steps to form a substantially continuous coating of ejectant on the substrate.

In some embodiments, the body is a rotatable drum.

In some embodiments, the relative movements of the body are caused by rotation of the rotatable drum.

In some embodiments, the first surface of the body is the inside surface of the drum and the second surface of the drum is the outside surface of the drum.

In some embodiments, the barrier fluid and the ejectant are miscible. In other embodiments, the barrier fluid and the ejectant are immiscible.

In some embodiments, the barrier fluid and the ejectant comprise one or more common components.

In some embodiments, the one or more common components are carrier components of the ejectant. In some embodiments, each of the one or more carrier components is a solvent component or a continuous-phase component of the ejectant.

In some embodiments, the barrier fluid comprises the one or more common components in a total amount of at least 70% by weight of the barrier fluid.

In some embodiments, the barrier fluid comprises a dominant component that is also a component of the ejectant.

In some embodiments, the dominant component is a carrier component of the ejectant. In some embodiments, the carrier component is a solvent component or a continuous-phase component of the ejectant.

In some embodiments, the barrier fluid comprises the dominant component in an amount of at least 90% by weight.

In some embodiments, the barrier fluid and the ejectant are both aqueous fluids.

In some embodiments, the ejectant comprises a polyvinyl acetate (PVA) glue.

In some embodiments, the barrier fluid comprises water in an amount of at least about 90% by weight.

In some embodiments, the barrier fluid comprises a wetting agent.

In some embodiments, the barrier fluid and the ejectant are both oil-based fluids.

In some embodiments, the barrier fluid and the ejectant are substantially immiscible.

In some embodiments, the barrier fluid is an aqueous fluid and the ejectant is an oil-based fluid. In other embodiments the barrier fluid is an oil-based fluid and the ejectant is an aqueous fluid.

In some embodiments, the supply orifice is the second orifice. In some embodiments, the step of supplying the barrier fluid to each of the one or more nozzles further comprises depositing barrier fluid onto the second surface of the body. In some embodiments, depositing barrier fluid onto the second surface of the body reduces adhesion of the ejectant to the second surface of the body.

In some embodiments, the barrier fluid is supplied to the one or more nozzles in an amount by weight of 5 to 40% relative to the total amount by weight of the ejectant and the barrier fluid supplied to the one or more nozzles.

In some embodiments, the barrier fluid is supplied to the one or more nozzles in an amount by weight of 10 to 30% relative to the total amount by weight of the ejectant and the barrier fluid supplied to the one or more nozzles.

According to a second aspect of the disclosure, a fluid ejector for ejecting discrete volumes of ejectant is provided. The fluid ejector comprises a body having opposed first and second surfaces and at least one nozzle defined between the first and second surfaces. Each of the at least one nozzle is defined by a conduit extending through the body to connect a first orifice formed in the first surface of the body and a second orifice formed in the second surface of the body. The fluid ejector further comprises a barrier fluid supplier for supplying barrier fluid to each of one or more nozzles of the at least one nozzle via a supply orifice of each of the one or more nozzles. The supply orifice is the first orifice or the second orifice of the nozzle. The body and the barrier fluid supplier are movable relative to each other. The fluid ejector further comprises an ejectant supplier for supplying ejectant to each of the one or more nozzles via the second orifice of each of the one or more nozzles. The body and the ejectant supplier are movable relative to each other. The fluid ejector further comprises an ejector for imparting an ejection force to ejectant contained within each of the one or more nozzles. In use, the fluid ejector performs a barrier fluid supply step in which relative movement of the barrier fluid supplier and the body causes the supply orifice of each of the one or more nozzles to be exposed to the barrier fluid supplier to supply the barrier fluid to each of the one or more nozzles via the supply orifice of each of the one or more nozzles. In use, the fluid ejector then performs an ejectant supply step in which relative movement of the ejectant supplier and the body causes the second orifice of each of the one or more nozzles to be exposed to the ejectant supplier to supply the ejectant to each of the one or more nozzles via the second orifice of each of the one or more nozzles, In use, the fluid ejector then performs an ejection step in which the ejector imparts an ejection force to the ejectant contained within each of the one or more nozzles to cause ejection of at least some of the ejectant from each of the one or more nozzles via the second orifice of each of the one or more nozzles.

In some embodiments, the ejector is configured to impart an ejection force to the barrier fluid contained within each of the one or more nozzles. In some embodiments, in use, the ejector imparts an ejection force to the barrier fluid contained within each of the one or more nozzles to cause ejection of at least some of the barrier fluid from each of the one or more nozzles via the second orifice of each of the one or more nozzles.

In some embodiments, the ejector comprises a gas supplier for supplying pressurised gas to each of the one or more nozzles via the first orifice of each of the one or more nozzles. In some embodiments, in use, the first orifice of each of the one or more nozzles is exposed to the gas supplier to supply pressurised gas to each of the one or more nozzles via the first orifice of each of the one or more nozzles to cause ejection of the at least some of the ejectant from each of the one or more nozzles via the second orifice of each of the one or more nozzles.

In some embodiments, the body and the gas supplier are movable relative to each other. In some embodiments, in use, relative movement of the gas supplier and the body causes the first orifice of each of the one or more nozzles to be exposed to the gas supplier to supply the pressurised gas to each of the one or more nozzles via the first orifice of each of the one or more nozzles to cause ejection of the at least some of the ejectant from each of the one or more nozzles via the second orifice of each of the one or more nozzles.

In some embodiments, in use, the barrier fluid supplier contacts the surface of the body in which the supply orifice is formed to effect the supply of the barrier fluid to each of the one or more nozzles.

In some embodiments, in use, the barrier fluid supplier contacts the surface of the body in which the supply orifice is formed to clean residue from the surface of the body in which the supply orifice is formed in the vicinity of each first orifice or second orifice of the one or more nozzles.

In some embodiments, the supply orifice is the second orifice, and wherein the residue comprises the ejectant.

In some embodiments, a displacement of the barrier fluid supplier relative to the body is adjustable so that a pressure applied to the surface of the body in which the supply orifice is formed by the barrier fluid supplier when in use is adjustable to control the amount of barrier fluid supplied to each of the one or more nozzles.

In some embodiments, the barrier fluid supplier comprises a barrier fluid reservoir configured to, in use, supply the barrier fluid to the one or more nozzles.

In some embodiments, the barrier fluid reservoir comprises an absorbent medium.

In some embodiments, the absorbent medium is configured to absorb the barrier fluid and distribute the barrier fluid across a portion of a contact surface of the barrier fluid supplier that contacts the surface of the body in which the supply orifice is formed to effect supply of the barrier fluid to each of the one or more nozzles.

In some embodiments, the absorbent medium comprises a sponge.

In some embodiments, in use, the absorbent medium contacts the surface of the body in which the supply orifice is formed to effect the supply of the barrier fluid to each of the one or more nozzles.

In some embodiments, the barrier fluid supplier comprises a contact layer overlaying the absorbent medium. In some embodiments, in use, the contact layer contacts the surface of the body in which the supply orifice is formed to effect the supply of the barrier fluid to the one or more nozzles.

In some embodiments, the contact layer has a more uniform surface profile than the absorbent medium.

In some embodiments, the contact layer facilitates a uniform supply of the barrier fluid to each of the one or more nozzles.

In some embodiments, the contact layer is formed from a porous material.

In some embodiments, the contact layer is formed from a fabric or a chamois.

In some embodiments, the barrier fluid supplier comprises a filler that is shaped to cooperate with the surface of the body in which the supply orifice is formed when in use to define a cavity that defines the barrier fluid reservoir.

In some embodiments, the filler comprises a resilient member that, in use, contacts the surface of the body in which the supply orifice is formed to remove residue from the surface of the body in which the supply orifice is formed.

In some embodiments, in use, the barrier fluid supplier is positioned relative to the body such that supply of the barrier fluid to each of the one or more nozzles is gravity assisted.

In some embodiments, in use, the barrier fluid supplier contacts an upward-facing portion of the surface of the body in which the supply orifice is formed.

In some embodiments, the barrier fluid supplier comprises a barrier fluid feed configured to supply barrier fluid to the barrier fluid reservoir, and wherein a flow rate of the barrier fluid feed is adjustable.

In some embodiments, the ejectant supplier contacts the second surface of the body to effect the supply of the ejectant to each of the one or more nozzles.

In some embodiments, the ejectant supplier comprises an ejectant reservoir configured to, in use, supply the ejectant to each of the one or more nozzles.

In some embodiments, the ejectant supplier comprises a filler that is shaped to cooperate with the second surface of the body when in use to define a cavity that defines the ejectant reservoir.

In some embodiments, the ejectant supplier comprises an ejectant feed configured to supply ejectant to the ejectant reservoir. In some embodiments, a flow rate of the ejectant feed is adjustable.

In some embodiments, the body is a rotatable drum, wherein the relative movements are caused by rotation of the rotatable drum. In some embodiments, the first surface of the body is the inside surface of the drum and the second surface of the drum is the outside surface of the drum.

In some embodiments, in use, the supply of the barrier fluid to each of the one or more nozzles reduces adhesion of the ejectant to an interior surface of each of the one or more nozzles.

In some embodiments, in use, once the barrier fluid and the ejectant have been supplied to each of the one or more nozzles the barrier fluid at least partially coats the interior surface of each of the one or more nozzles, thereby reducing adhesion of the ejectant to the interior surface of each of the one or more nozzles.

In some embodiments, the supply orifice is the second orifice. In some embodiments, in use, the barrier fluid supplier deposits barrier fluid onto the second surface of the body, thereby reducing adhesion of the ejectant to the second surface of the body.

In some embodiments, the ejector is configured to impart the ejection force to the ejectant contained within each of the one or more nozzles to eject the ejectant onto a substrate.

In some embodiments, in use, the fluid ejector continuously repeats the barrier fluid supply step, the ejectant supply step, and the ejection step. In some embodiments, in use, the fluid ejector continuously repeats the barrier fluid supply step, the ejectant supply step, and the ejection step to form a substantially continuous coating of ejectant on the substrate.

According to a third aspect of the disclosure, a barrier fluid supplier for a fluid ejector as described herein is provided.

### BRIEF DESCRIPTION OF THE DRAWINGS

Embodiments of this disclosure will now be described in detail with reference to the accompanying drawings, in which:

FIGS. 1a, 1b, and 1c show schematically a cross-section of an apparatus for ejecting a pattern of discrete volumes of ejectant, at different stages of operation, consistent with WO 2017/141034 A1;

FIG. 2 shows schematically a cross-section of another apparatus for ejecting a pattern of discrete volumes of ejectant, consistent with WO 2017/141034 A1;

FIGS. 3a and 3b show cross-sectional views of another apparatus for ejecting discrete quantities of ejectant, consistent with WO 2017/141034 A1;

FIGS. 4a and 4b show schematically a cross-section of a nozzle at different stages of having ejectant ejected therefrom;

FIG. 5 shows schematically a cross-section of an apparatus for ejecting a pattern of discrete volumes of ejectant, in accordance some embodiments of the present disclosure.

FIGS. 6a to 6d show schematically a cross-section of a nozzle at different stages of having barrier fluid and ejectant loaded therein and ejected therefrom, in accordance with some embodiments of the present disclosure;

FIG. 7 shows schematically a cross-section of a part of a barrier fluid supply assembly for supplying barrier fluid into nozzles of a nozzle-bearing body, in accordance with some embodiments of the present disclosure;

FIG. 8 depicts a flow diagram of a method for ejecting discrete volumes of ejectant, in accordance with some embodiments of the present disclosure;

FIGS. 9a and 9b show photographs of the surface of the nozzle-bearing body used in Reference Example 1;

FIG. 10 shows a photograph of the surface of the nozzle-bearing body used in Reference Example 2;

FIG. 11 shows a photograph of the surface of the nozzle-bearing body used in Example 1.

Throughout the accompanying drawings, unless otherwise specified, like reference signs (either the same reference sign/number or reference numbers separated by a multiple of 100) are used to denote the same or corresponding features.

### DETAILED DESCRIPTION

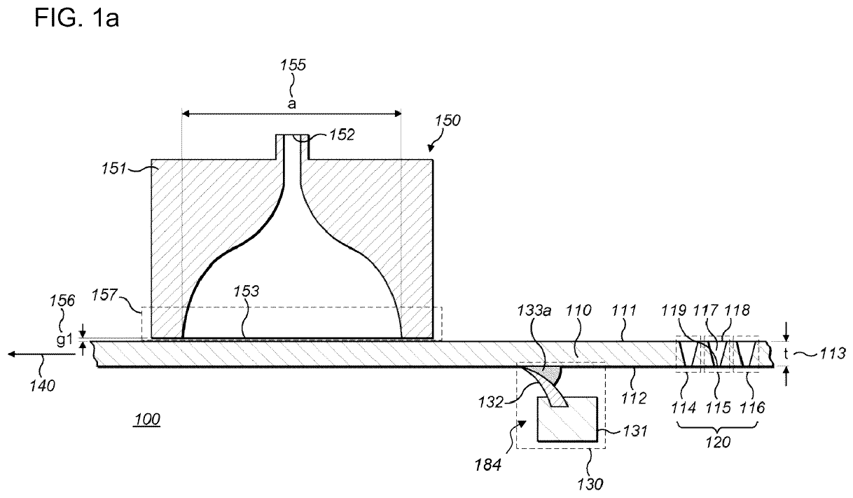

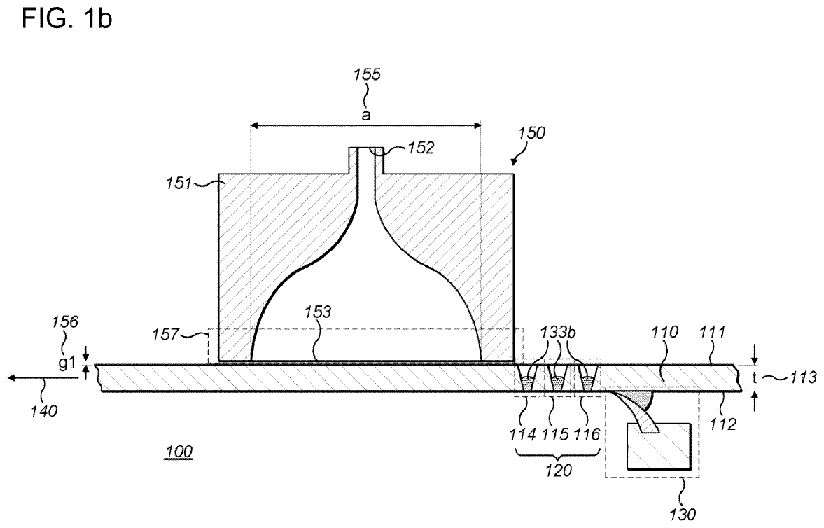

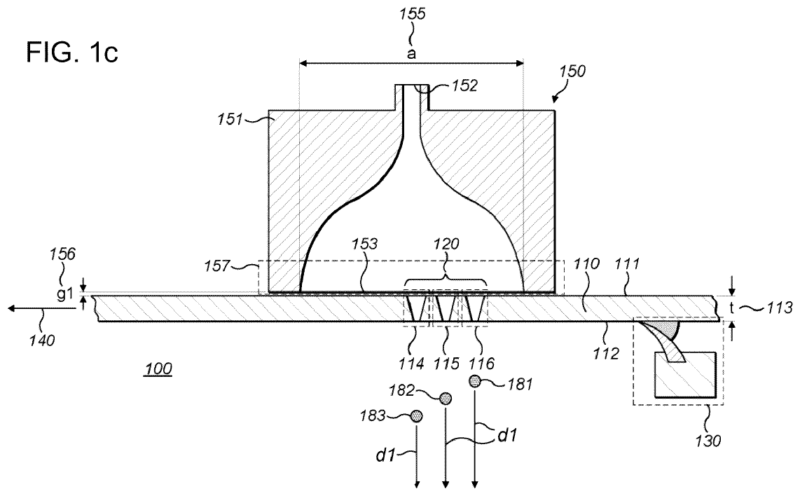

FIG. 1a shows schematically a cross-section of apparatus 100 (also referred to herein as a device, a fluid ejector, or a fluid ejector apparatus) for ejecting therefrom a pattern of discrete volumes of ejectant consistent with WO 2017/141034 A1, the entire content of which is hereby incorporated by reference.

In the context of this disclosure, the term ‘ejectant’ encompasses any flowable material, or fluid, such as those materials whose constituent parts or sub-volumes are capable of relative motion, and includes, but is not limited to, liquids, liquid solutions, suspensions, emulsions, gels, waxes and oils. The ejectant may therefore be referred to as a fluid ejectant, or liquid ejectant.

In the context of this disclosure, the ejectant may be an aqueous fluid. For example, the ejectant may comprise water as a carrier fluid, such as a solvent (when the ejectant is a solution) or a continuous-phase component (when the ejectant is an emulsion or suspension). For example, the ejectant may be an aqueous solution, aqueous suspension or other aqueous mixture. In particular, the ejectant may be an emulsion in which the continuous phase is or comprises water (otherwise known as a water-based emulsion). For example, the ejectant may be an oil-in-water emulsion or a polymer-in-water emulsion, such as a latex-in-water emulsion or an acrylic-in-water emulsion. Examples of water-based emulsion ejectants include water-based emulsion paints (otherwise known simply as emulsion paints) and water-based emulsion glues or adhesives, such as polyvinyl acetate glue, otherwise known as PVA glue, wood glue, white glue, carpenter's glue, school glue, or Elmer's glue. More generally, therefore, the ejectant may be a water-borne or water-based mixture, fluid, liquid, or coating, and may be in the form of an emulsion, a suspension, a solution, or other form of mixture. In other words, the base fluid of the ejectant may be water. The ejectant may comprise or consist of one or more of (or any combination of) water-based paint, water-based adhesive, water-based varnish, water-based primer, water-based sealant, water-based corrosion inhibitor, water-based ink, water-based leather finish, water-based dye, water-based antimicrobial coating, water-based lubricant, water-based flavouring.

Alternatively, in the context of this disclosure, the ejectant may be a non-aqueous fluid. For example, the ejectant may be an oil-based, or oil-borne fluid. For example, the ejectant may comprise one or more oils as carrier fluid components, such as solvents (when the ejectant is a solution) or continuous-phase components (when the ejectant is an emulsion or suspension). For example, the ejectant may be an oil-based or oil-borne solution, suspension or other oil-based or oil-borne mixture. The ejectant may be an emulsion in which the continuous phase is or comprises one or more oils (otherwise known as an oil-based emulsion). For example, the ejectant may be a water-in-oil emulsion. More generally, the ejectant may be an oil-borne or oil-based mixture, fluid, liquid, or coating, and may be in the form of an emulsion, a suspension, a solution, or other form of mixture. In other words, the base fluid of the ejectant may comprise one or more oils. Examples of oil-based ejectants include oil-based paints.

Another possibility in the context of this disclosure, is that the ejectant is a solvent-based (specifically an organic-solvent based) fluid. For example, the ejectant may be a solvent-based, or solvent-borne fluid. For example, the ejectant may comprise one or more organic solvents as carrier fluid components. For example, the ejectant may be a solvent-based or solvent-borne solution, suspension or other solvent-based or solvent-borne mixture.

Other types of ejectant may also be used in the context of this disclosure. For example, the ejectant may be ejected in the form of a hot-melt. The ejectant may, for example, be a hot-melt glue. As will be appreciated by a person skilled in the art, hot-melt ejectants are solid at room temperature and pressure and are heated into a molten state for application (in the case of the present disclosure, application involves supply to the nozzles and ejection therefrom).

In general, in the context of this disclosure the ejectant may be a coating or coating fluid, such as a paint, glue, or other coating.

The term ‘gas’, as used herein, encompasses a gas, mixture(s) of gases, a vapour, mixture(s) of vapours, and mixtures of vapour(s) and gas(es).

Apparatus 100 includes body 110, ejectant supply assembly 130 (also referred to herein as ejectant supplier), gas supply assembly (also referred to herein as gas supplier) comprising gas supply head 150, and translation means (not shown) for translating body 110 relative to ejectant supply assembly 130 and/or gas supply head 150, for example, for translating body 110 in the general direction of arrow 140 shown in FIG. 1a.

Body 110 has first surface 111 and second surface 112, opposite (i.e. on an opposite side of body 110) first surface 111, which are separated by thickness 113—shown as ‘t’. Body 110 is perforated to form pattern 120 of nozzles 114, 115, and 116 within body 110. In particular, each nozzle is defined by a conduit extending through thickness 113 of body 110 and connecting corresponding orifices defined at first surface 111 and second surface 112 of body 110. For example, nozzle 115 is defined by conduit 117 connecting first orifice 118 defined at first surface 111 and second orifice 119 defined at second surface 112. Other nozzles defined within body 110, such as nozzles 115 and 116 shown in FIG. 1a, are similarly structured.

Ejectant supply assembly 130 includes holder 131 and resilient seal member 132 (e.g., a wiper blade seal) that extends from holder 131. Together, holder 131 and resilient seal member 132 form filler 184 (also referred to as ejectant guide, ejectant loader, or nozzle filler) of ejectant supply assembly. As can be seen in FIGS. 1a to 1c, holder 131 is configured to be placed proximate to second surface 112 of body 110 so as to provide for a pressure-bearing contact between resilient seal member 132 and second surface 112.

In use, resilient seal member 132 and second surface 112 cooperate to define an ejectant reservoir therebetween. Ejectant 133a is deposited in the ejectant reservoir defined between resilient seal member 132 and second surface 112 such that as holder 131 along with resilient seal member 132 travels relative to body 110, ejectant 133a travels along second surface 112, for example, in the direction opposite of the direction indicated by arrow 140. Thus, in use ejectant 133a is in contact with resilient seal member 132 and a portion of second surface 112 that has not yet passed resilient seal member 132 in direction 140.

In some example embodiments, a single-use volume of ejectant 133a is deposited between resilient seal member 132 and second surface 112 so as to enable refill of nozzles 114, 115, and 116 of nozzle pattern 120 via their second (supply) orifices during a single pass of body 110 relative to ejectant supply assembly 130. In some example embodiments however a multiple-use (e.g., on-demand) ejectant supply is provided.

The relative translation (movement) of body 110 to ejectant supply assembly 130 in direction 140 causes resilient seal member 132 to move ejectant 133a over second surface 112 of body 110. This movement, together with the drag force between ejectant 133a and body 110 (for example, the viscous drag force if the ejectant is a fluid), causes a pressure gradient to be generated in the ejectant volume such that the pressure in that portion of ejectant 133a adjacent to resilient seal member 132 rises above ambient pressure. Consequently, as that portion of ejectant 133a passes over second orifices of nozzles 114, 115, and 116, it is pushed into nozzles 114, 115, and 116, such as shown in FIG. 1b at 133b. In this manner, ejectant supply assembly 130 partially or wholly fills nozzles 114, 115, and 116 with a discrete quantity of ejectant 133a. Filler 184 is therefore configured to guide or load ejectant into nozzles 114, 115 and 116.

As understood by those skilled in art, the term ‘ambient pressure’ with reference to a particular object means the pressure on the object by the medium (environment) surrounding that object. The medium typically is air at atmospheric pressure, although it may differ. For example, an apparatus and/or a method according to embodiments of the present disclosure may be practised inside fume cabinets filled with air but operated at pressures below atmospheric pressure and/or in environments filled with inert gases to prevent, for example, oxidation of materials within those environments. The present disclosure follows this conventional definition of the term ‘ambient pressure’. In context of this definition, it should be understood that the term ‘pressurised gas’ as used herein refers to gas pressurised to a pressure above ambient pressure.

The degree to which nozzles 114, 115, and 116 are filled generally depends on the material of resilient seal member 132, the angle between resilient seal member 132 and second surface 112, the relative speed of second surface 112 to resilient seal member 132, the geometry of nozzles 114, 115, and 116, and the properties of ejectant 133a, such as, in the case of liquid ejectants, viscosity and surface tension. For example, nozzles 114, 115, and 116 can be completely filled with ejectant 133a under the following conditions: resilient seal member 132 is made of Polyvinyl Chloride (PVC) and has thickness of 0.5 mm and a length of 20 mm. Resilient seal member 132 is placed at an angle of 20 degrees or less in relation to second surface 112, the relative speed of second surface 112 to resilient seal member 132 is 3 cm/s, ejectant 133a has viscosity of 10⁷ mPas at shear rate 0.001 s⁻¹ and viscosity of 10³ mPas at shear rate of 10 s⁻¹, the diameter of nozzles 114, 115, and 116 at second surface 112 is 0.5 mm, and thickness 113 of the body 110 is 1.4 mm. To fill nozzles 114, 115, and 116 only partially, the angle between resilient seal member 132 and second surface 112 is increased.

In use, gas supply head 150 is positioned adjacent to first surface 111 of body 110. Gas supply head 150 may be formed of solid walls 151, which define gas outlet 153 and gas inlet 152. Generally, gas supply head 150 receives gas through gas inlet 152 and outputs the gas through gas outlet 153. Gas outlet 153 is defined at end portion 157 of gas supply head 150 that is adjacent to body 110 whilst gas inlet 152 can substantially be defined at any portion of gas supply head 150, other than gas outlet 153 itself. In FIG. 1a, gas inlet 152 is shown to be formed at an end portion of gas supply head 150 that is opposite end portion 157.

Gas outlet 153 may take different shapes. However, its dimensions in a plane substantially corresponding (e.g., parallel) to the plane of first surface 111, such as its width 155 identified as ‘a’ and length, and/or a diameter, should preferably be greater than those of the largest first orifice within pattern 120 of nozzles 114, 115, and 116, so as to encompass the largest orifice when gas outlet 153 and the orifice are aligned.

Further translation of body 110 relative to ejectant supply assembly 130 in direction 140 also provides translation of body 110 relative to gas supply head 150. Such translation results in one or more of nozzles 114, 115, and 116 passing under gas outlet 153, and thus being exposed to the pressure of gas at gas outlet 153, as shown in FIG. 1c. The time set for this further translation is selected to be sufficiently short so as to retain ejectant 133b within nozzles 114, 115, and 116. The flow properties, such as, in the case of liquid ejectants, the viscosity and/or surface tension of ejectant 133b, allow nozzles 114, 115, and 116 to retain ejectant 133b therein.

In use, an external supply of gas (not shown) supplies gas into gas inlet 152 at a pressure sufficiently above ambient pressure. When one or more of nozzles 114, 115, and 116 become exposed to the pressure of gas at gas outlet 153, that pressure causes ejection of the at least some of, and preferably substantially all of, ejectant 133b from nozzles 114, 115, and 116. In particular, the ejection is caused by the pressure difference created between respective orifices of each nozzle due to the pressurised gas supplied from gas outlet 153. The time duration of exposure to the gas pressure required to cause ejection of the ejectant from a nozzle may differ depending on, for the example, the pressure of the supplied gas (pressurised gas), dimensions of the nozzle, and/or the flow characteristics and volume of the ejectant.

As stated above, the pressure within gas supply head 150 may be achieved by the supply of gas at a pressure above ambient pressure to gas supply head 150. That pressure may be continuous (not varying with time) or pulsatile (time-varying). In apparatus 100 with a pulsatile pressurisation of gas, the pressure pulses are timed to coincide with the times at which the nozzles are exposed to the gas at gas outlet 153. The gas is supplied at a pressure above ambient during each pulse and at a pressure above the gas pressure between successive pulses.

Such gas pressure pulses may for example be provided using a supply of continuously pressurised gas in combination with an electrically controllable gas valve (not shown) positioned between gas inlet 152 and an external gas supply (not shown), preferably adjacent to gas inlet 152. Such a gas valve should be capable of rapid opening and closing (for example, opening within 100 milliseconds and closing within a further 100 milliseconds). Spool valves operated by solenoid actuators are suitable for this purpose.

Apparatus 100 with continuous and/or pulsatile supply of gas under pressure can thereby deposit a pattern of discrete volumes of ejectant upon a substrate.

For uniform ejection of the ejectant from all nozzles, it is preferable to keep the gas pressure (whether continuous or pulsatile) substantially uniform at gas outlet 153 (where nozzles 114, 115, and 116 are exposed to that pressure). For many applications, gas outlet 153 has a rather small width ‘a’ (for example 2 mm), whilst its length may extend substantially (for example 100 mm), in the perpendicular direction (i.e., normal to the cross-section shown in FIGS. 1a, 1b and 1c). Adequately uniform pressure can be obtained in this configuration whilst operating using continuous pressure, by using multiple gas inlets (not shown) distributed along a path corresponding to the length of gas outlet 153 and connected to a common pressurised gas supply. If pulsatile pressure is used instead, then additionally, it is preferable to maintain the frequency of pressure pulses at frequencies lower than that frequency at which half the wavelength of sound in the gas within gas supply head 150 equals the smallest cross-sectional (width) dimension of gas supply head 150.

In some embodiments, to minimise gas consumption by apparatus 100, gas outlet 153 and first surface 111 of body 110 are maintained in close proximity. In particular, gap ‘g1’, shown at 156, between gas outlet 153 and first surface 111 is characterised by a small value, whenever gas is supplied under pressure to gas supply head 150. Preferably, the small value is selected such that the flow of gas through gap ‘g1’ is smaller than the flow of gas through the nozzles when the nozzles are empty. Further preferably, the small value is selected such that the flow of gas through gap ‘g1’ is smaller than the flow of gas through the nozzles when ejecting ejectant. By surrounding gas outlet 153 with a sliding seal (not shown) between gas supply head 150 and first surface 111, gap ‘g1’ may be set to zero.

In a general case, however, gap ‘g1’ is non-zero, and thus the pressure versus flow rate characteristic of the gas supply is selected to ensure that the gas pressure at gas outlet 153 remains sufficiently above ambient pressure to eject ejectant 133b from nozzles 114, 115, and 116. The gas may be any compound that is in gaseous phase at the operating temperature of the apparatus and which does not have deleterious reaction with ejectant 133b or materials of gas supply head 150. In many practical applications, the gas can include for example compressed air, nitrogen, or pressurised steam.

Further, for some applications, it is preferable to keep the gas pressure inside gas supply head 150 constant and uniform throughout the inner volume of gas supply head 150. This can for example be achieved by making the physical dimensions of the interior of gas supply head smaller than a half of the wavelength of sound where the wavelength is calculated at frequency of the pulsing operation of the gas supply.

Referring to FIG. 1c, in an example scenario, ejectant 133b is a liquid of high viscosity (e.g., in the range 100 mPas to 108 mPas). The gas pressure inside gas supply head lies in the range 7×10³ N/m² to 1×10⁶ N/m². First and second orifices 118 and 119 of the nozzles at first and second surfaces 111 and 112 respectively are both chosen to have diameter 500 micrometres. The ejectant is exposed to the ejecting gas pressure for a time period in the range of 1 ms to 100 ms. The thickness ‘t’ of body 110 is 1.5 mm. Under these conditions, ejectant 133b would typically be ejected from nozzles 114, 115, and 116, through the orifices at second surface 112.

In apparatus 100 shown in FIG. 1c, nozzles 114, 115, and 116 direct ejections of the ejectant in substantially common direction “d1” as shown at 181, 182, and 183. However, certain applications may require nozzles 114, 115, and 116 to have different directionalities (e.g., different inclines within body 110 with reference to first and second surfaces) such that the ejections from nozzles 114, 115, and 116 will not follow the common direction.

Although FIGS. 1a to 1c show an ejector which has the gas supply head and the body movable relative to each other, in some embodiments, the position of the gas supply head is fixed (stationary) in relation to the body. This arrangement is particularly suitable for ejecting ejectants onto a conveyer system with a substrate, web, or the like continuously or intermittently moving in relation to the nozzles defined within a body of the ejector, thereby enabling the ejector to deposit the ejectant onto new sections of the substrate, web, or the like.

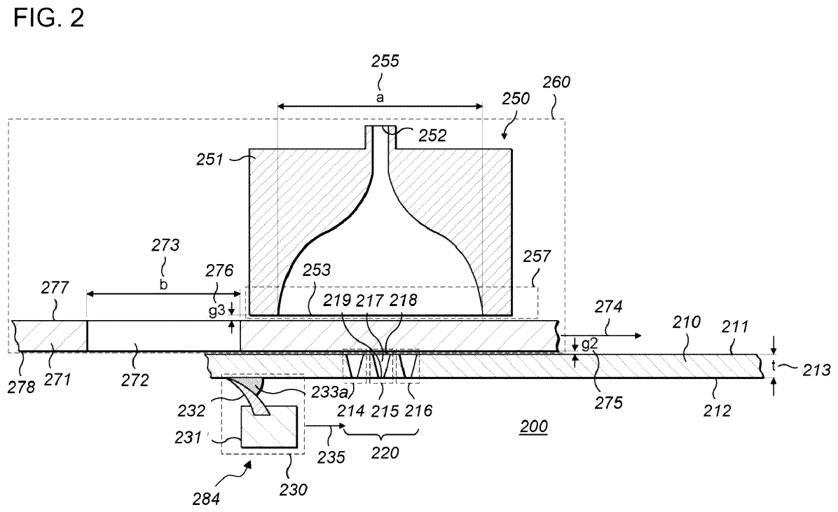

FIG. 2 shows schematically a cross-section of another apparatus 200 for ejecting a pattern of discrete volumes of ejectant, consistent with WO 2017/141034 A1. Generally, apparatus 200 is a variation of apparatus 100 described with reference to FIGS. 1a to 1c that includes many of the functional components described in respect of FIGS. 1a to 1c. More specifically, similar to apparatus 100, apparatus 200 has a body, an ejectant supply assembly, and a gas supply head identified respectively as 210, 230, and 250, and translation means (not shown) for translating ejectant supply assembly 230 and body 210 relative to each other.

Similar to body 110 of apparatus 100, body 210 has first surface 211 and second surface 212, opposite first surface 211, which are separated by a thickness 213—shown as ‘t’. Body 210 is perforated to form pattern 220 of nozzles 214, 215, and 216 in body 210. Each nozzle is defined by a conduit extending through thickness 213 to connect corresponding orifices defined at first surface 211 and second surface 212 of body 210. For example, nozzle 215 is defined by conduit 217 connecting first orifice 218 defined at first surface 211 and second orifice 219 defined at second surface 212. The other nozzles defined within body 210, such as nozzles 214 and 216 shown in FIG. 2, are similarly structured.

Similar to the ejectant supply assembly 130 of apparatus 100, ejectant supply assembly 230 comprises ejectant supply body 231 configured to hold ejectant 233a, such as an ejectant liquid, and resilient seal member 232 that extends from ejectant supply body 231. Together, ejectant supply body 231 and resilient seal member 232 form filler 284. As can be seen in FIG. 2, ejectant supply assembly 230 is configured to be placed adjacent to body 210 so as to provide for a pressure-bearing contact between resilient seal member 232 and second surface 212 of body 210.

However, unlike apparatus 100, in apparatus 200, a further component of an aperture member is provided for use in combination with gas supply head 250, together forming gas supply head system 260. In FIG. 2, this further component is shown in the form of translatable aperture plate 271 having opposite surfaces 277 and 278 and aperture 272 defined therethrough. Plate 271 is positioned between gas supply head 250 and body 210.

In apparatus 200, body 210 and solid walls 251, which form gas supply head 250, are held in relation to each other such that when aperture 272 of aperture plate 271 is positioned at (below) gas outlet 253 of gas supply head 250, one or more of nozzles 214, 215, and 216 are exposed to the gas pressure from gas outlet 253 defined by gas supply head 250. Such an alignment between gas outlet 253 and aperture plate 271 is referred herein as an open position.

The dimensions of gas outlet 253 and of aperture 272 (such as the width dimensions of gas outlet 253, shown as ‘a’ at 255, and of aperture 272, shown as ‘b’ at 273, and the respective length dimensions, not shown), in a plane substantially corresponding (e.g., parallel) to the plane of first surface 211 of body 210 are preferably greater than those of the largest orifice of nozzles 214, 215, and 216 defined at first surface 211 of body 210.

However, when aperture plate 271 is displaced in relation to gas supply head such that aperture 272 is moved away from gas outlet 253 in either direction, aperture plate 271 prevents pressure of gas admitted into gas supply head 250 from being communicated into nozzle pattern 220 via gas outlet 253. This shift of aperture 272 in relation to gas outlet 253 is referred herein as a closed position, for example as seen in FIG. 2.

Whilst aperture plate 271 is in this closed position, ejectant supply assembly 230 can be translated (by any of a number of known translation means, not shown) relative to body 210 towards and past nozzles 214, 215, and 216. In FIG. 2, such translation is indicated by arrow 235. At the same time, ejectant 233a travels from ejectant supply body 231 towards body 210 by the way of resilient seal member 232. Thus, translation of ejectant supply assembly 230 relative to body 210, past nozzles 214, 215, and 216, whilst under pressure exerted by resilient seal member 232, results in quantities of ejectant 233a being supplied from ejectant supply body 231 into nozzles 214, 215, and 216.

Once nozzles 214, 215, and 216 have been filled, aperture plate 271 is translated (moved) through the open position so as to temporarily align aperture 272 with gas outlet 253 to allow the pressure of gas admitted into gas supply head 250 to be briefly communicated via gas outlet 253 and through aperture 272 to nozzle pattern 220. In FIG. 2, such translation is indicated by arrow 274.

In some embodiments, to minimise gas consumption by the apparatus 200, whenever gas is supplied under pressure to gas supply head 250, close proximity is maintained between portion 257 of walls 251 that defines gas outlet 253 and surface 277 of aperture plate 271. Close proximity may also be maintained between surface 278 of aperture plate 271 and first surface 211 of body 110 whenever aperture plate 271 is in the open position. In this open position, aperture 272 allows the pressure of the gas exiting gas supply head 250 through gas outlet 253 to reach one or more of nozzles 214, 215, and 216 through aperture 272 of aperture plate 271.

The close proximity of gas supply head 250, aperture plate 271, and body 210 is characterised by small values of gap ‘g2’ shown at 275 between body 210 and aperture plate 271 and gap ‘g3’ shown at 276 between aperture plate 271 and gas outlet 253. Gaps ‘g2’ and ‘g3’ can be set to zero by providing a sliding seal (not shown) between aperture plate 271 and each of gas supply head 250 and body 210. In some embodiments, the sliding seal is realised by incorporating a layer of solid lubricant or low-friction material, such as high density polyethylene, into or onto surfaces 277 and 278 of aperture plate 271.

In use, an external supply of gas (not shown) supplies gas into gas inlet 252 at a pressure sufficiently above ambient pressure to cause the ejectant to eject from nozzles 214, 215 and 216 within that time during which aperture 272 passes gas outlet 253 to expose those nozzles to the gas pressure at gas outlet 253. The gas may be supplied to gas supply head 250 with continuous or pulsatile pressure by means and methods similar to those described with reference to FIGS. 1a to 1c.

In a general scenario with either or both gaps ‘g2’ and ‘g3’, shown at 275 and 276 respectively, being non-zero, the pressure versus flow rate characteristic of the gas supply is selected to ensure that the gas pressure at gas outlet 253 remains sufficiently above ambient pressure to eject the ejectant from nozzles 214, 215, and 216.

By providing aperture plate 271 and positioning aperture plate 271 in the closed position whilst filling nozzles 214, 215, and 216, the repeatability of volume of ejectant 233a filled into those nozzles can be improved and the over-filling of the nozzles can be more easily prevented. In addition, whether gas is supplied to apparatus 200 with continuous or pulsatile pressure, such an apparatus is particularly useful in ejecting patterns of ejectant onto a stationary substrate.

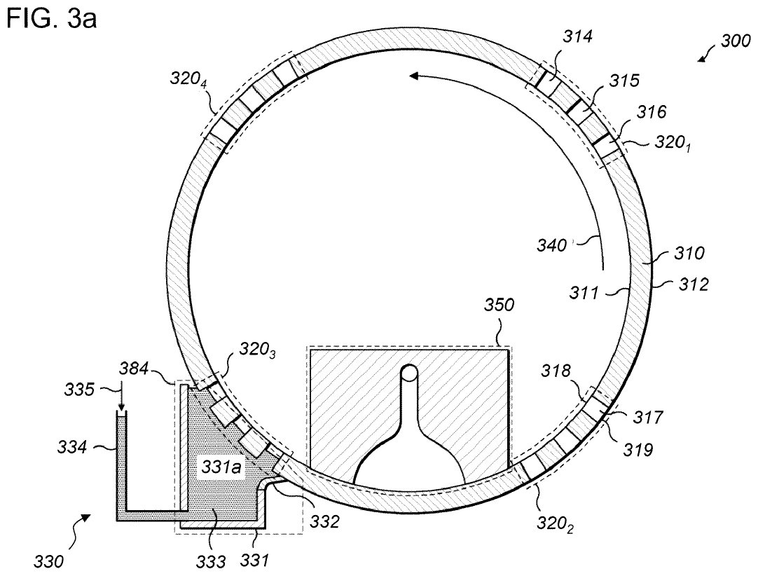

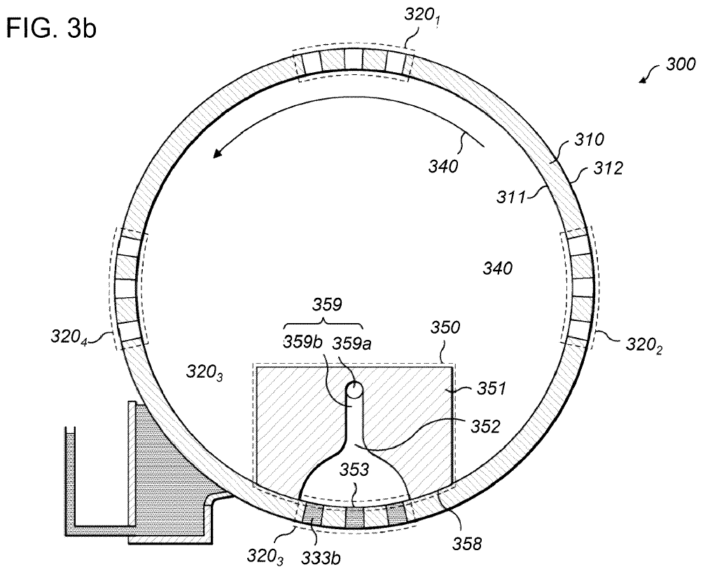

FIGS. 3a and 3b show cross-sectional views of another fluid ejector apparatus 300 consistent with WO 2017/141034 A1. Apparatus 300 has cylindrical or annular body 310 (also referred to as roller or drum) for ejecting discrete quantities of ejectant, according to some embodiments. Drum 310 is rigid and has a number of nozzles 314, 315, and 316 penetrating through the thickness of the drum from first, inner surface 311 of drum 310 to second, outer surface 312 of drum 310. Nozzles 314, 315, and 316 form nozzle pattern 320₁. Although annular body 310 is described as being cylindrical in the context of FIGS. 3a and 3b, in other embodiments consistent with the present disclosure the width or diameter of the annular body may vary along its axial length. Annular body or drum 310 may comprise at least one ring of nozzles forming an annular nozzle pattern extending around its circumference.

As shown, drum 310 may include a number of similar nozzle patterns 320₁, 320₂, 320₃, and 320₄ penetrating through the thickness of drum 310 from first surface 311 to second surface 312. Alternatively, nozzle pattern 320₁ may extend around the entire circumference of drum 310. Annular body or drum 310 may therefore comprise at least one annular nozzle pattern extending around its circumference. Such a continuous nozzle pattern is particularly useful when apparatus 300 is used to deposit a substantially continuous coating of ejectant onto a substrate, as described in further detail below. Each of nozzles 314, 315, and 316 within these patterns is defined by conduit 317 having first orifice 318 at first surface 311 and second orifice 319 at second surface 312, as shown by way of example for one of the nozzles in pattern 320₃. Each of nozzle patterns 320₁, 320₂, 320₃, and 320₄ may extend across a width of drum 310 in the axial direction (i.e. in the direction of the axis of rotation of the drum) ranging from the width of a single nozzle to substantially the entire width of drum 310. For example, each of nozzle patterns 320₁, 320₂, 320₃, and 320₄ may comprise either a single or a plurality of rows of nozzles spaced apart in the axial direction of drum 310. The width and arrangement of nozzle patterns 320₁, 320₂, 320₃, and 320₄ will depend on the intended use of fluid ejection apparatus 300. For example, where fluid ejection apparatus 300 is used to eject ejectant onto a substrate to form a substantially continuous coating on the substrate a single nozzle pattern extending around the entire circumference of drum 310 and comprising a plurality of rows of nozzles offset or spaced apart in the axial direction of drum 310 (i.e. across the width of drum 310) may be employed, for example to form a hexagonal closest-neighbours pattern of nozzles. In general, the width of nozzle patterns 320₁, 320₂, 320₃, and 320₄ in the axial direction of drum 310 may depend on the width of the coating layer to be applied to the substrate.

In use, drum 310 is rotated about its axis by auxiliary means (not shown), for example, in the anticlockwise direction shown by directional arrow 340. As drum 310 rotates, so does each of nozzle patterns 320₁-320₄, and thus each of these nozzle patterns successively passes ejectant supply assembly 330, which thereby supplies ejectant 333 into nozzles within these patterns.

In the embodiments of FIGS. 3a and 3b, ejectant supply assembly 330 includes housing 331, which is adjacent to, and extends along but not beyond, the axial length of drum 310. Housing 331 defines ejectant reservoir 331a that holds ejectant 333 for supplying such ejectant into the nozzle patterns of drum 310. Resilient seal member 332 (e.g., a wiper blade seal) extends from at least one side of housing 331, along the length of the housing, and forms a pressure-bearing sliding contact seal against second surface 312 of drum 310. Peripheral (or end) seals (not shown) are provided between the ends of housing 331 and drum 310. Ejectant supply assembly 330 further includes an ejectant feed assembly comprising ejectant feed pipe 334 for transporting ejectant 333 from a remote ejectant supply into housing 331, as shown by arrow 335. As shown in FIG. 3a, the ejectant feed assembly may supply ejectant into ejectant reservoir 331a below the upper surface of the ejectant held within ejectant reservoir 331a. The ejectant feed assembly may supply ejectant into a filled portion of reservoir 331a, i.e. a portion of reservoir 331a that, in use, contains ejectant. Put another way, the ejectant feed assembly may supply ejectant directly into the body of ejectant already contained in ejectant reservoir 331a. In some embodiments, the ejectant feed assembly may supply ejectant to a lower portion of reservoir 331a, e.g. below the supply region. In particular, the ejectant feed assembly may supply ejectant to reservoir 331a proximate to or through a base or a bottom wall of the ejectant supply assembly 330. Such an ejectant supply assembly 330 may be referred to as “base-filled” or “bottom-filled”. Reservoir 331a may comprise a storage region in which the ejectant is stored and a supply region from which the ejectant is supplied to the nozzles. The storage region may be located below the supply region. For example, referring to FIG. 3a, the supply region of reservoir 331a may be the portion of reservoir 331a bounded by the dashed line labelled 320₃, and the storage region may comprise the remainder of reservoir 331a. By supplying ejectant directly into the body of ejectant already contained in ejectant reservoir 331a the introduction of entrained air into the ejectant is avoided.

Housing 331, resilient seal member 332, the end-seals (not shown), and second surface 312 of drum 310 together form filler 384 of ejectant supply assembly 330. Ejectant supply assembly 330 can be filled and maintained filled with ejectant 333 which is supplied to ejectant supply assembly 330 via feed pipe 334 from the remote ejectant supply, as indicated by arrow 335. In use, ejectant supply assembly 330 is maintained filled with ejectant 333, whilst rotation of drum 310 causes each of nozzle patterns 320₁, 320₂, 320₃, and 320₄ to successively pass ejectant supply assembly 330. As the nozzles of the nozzle patterns (nozzle pattern 320₃, in FIGS. 3a and 3b) pass ejectant supply assembly 330, ejectant supply assembly 330 fills such nozzles with ejectant 333 partially or fully, depending on desired settings and requirements. In consequence, the nozzles within each nozzle pattern (for example, pattern 320₃) are successively partially- or fully-filled with discrete, and optionally metered, quantity 333b of ejectant 333.

FIGS. 3a and 3b show that continued rotation of the drum 310 in rotation direction 340 brings each nozzle pattern 320₁, 320₂, 320₃, and 320₄ successively underneath gas supply head 350 formed with solid walls 351. FIG. 3b shows nozzle pattern 320₃ in such a position. First orifice 318 of each of nozzles 314, 315, and 316 within nozzle pattern 320₃ is thereby exposed to the pressure of gas at gas outlet 353 of gas supply head 350. A substantially gas-tight seal is formed between surface 358 of walls 351 proximate to first surface 311 and first surface 311 of drum 310. This seal may, for example, be achieved by minimising the gap between those surfaces or, alternatively, by providing a sliding seal (not shown) between those surfaces.

In use, gas supply head 350 admits gas supplied to gas supply head 350 via conduit 359 (e.g., a drilled hole) formed within walls 351. Conduit 359 may be formed of a number of connected conduits, such as conduits 359a and 359b shown in FIG. 3b. There, conduit 359a directs gas from one end of drum 310 towards the inner cavity of gas supply head 350, whilst conduit 359b redirects the gas downwards to gas inlet 352 of gas supply head 350. In this manner, the gas is directed to gas outlet 353.

The pressurised gas supply (not shown) is arranged to provide a pressure sufficiently above ambient pressure so as to eject ejectant 333b from nozzles 314, 315, and 316 of nozzle pattern 320₃, for at least that time duration needed for ejection to occur. As discussed above, the ejection is caused by the pressure difference created between respective orifices of each nozzle due to the pressurised gas supplied from gas outlet 353.

Exposure of one or more of the nozzles in nozzle pattern 320₃ to that pressure for that time (i.e., the combination of time and pressure) thereby ejects ejectant 333b from those nozzles. In this manner, a pattern of ejectant according to the pattern of nozzles may be deposited onto a nearby substrate.

The fluid ejector apparatuses described with reference to FIGS. 1a to 1c, 2, 3a and 3b provide a number of advantages. For example, the above-described fluid ejectors advantageously enable dispensing of discrete quantities of fluids in a manner that is tolerant of varying operating conditions of practical industrial applications. Furthermore, the described fluid ejectors extend the practical applications of ejection of discrete, and optionally metered, quantities of ejectant to a wider range of ejectants, a wider range of ejection rates, and a wider range of volumes of ejected ejectant than those known in the ink-jet art.

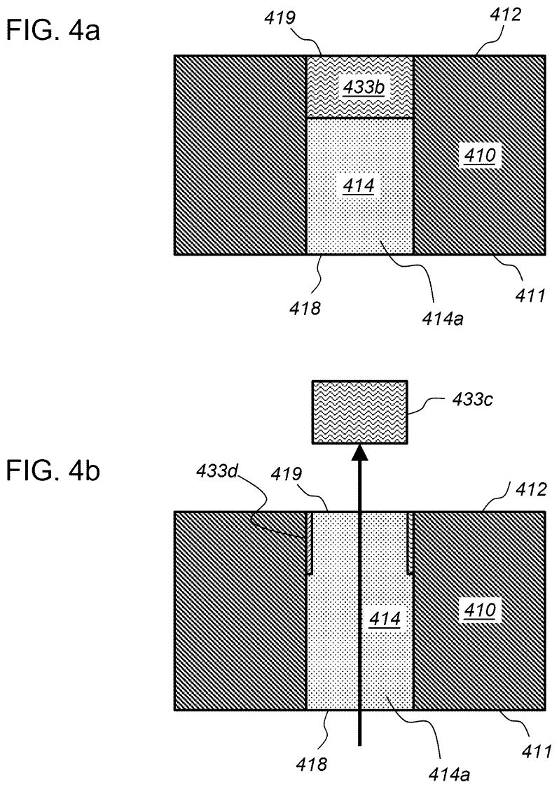

However, with reference to FIGS. 4a and 4b, when ejectant 433b is ejected from nozzle 414 some residual ejectant 433d may remain within nozzle 414 in contact with internal surface 414a of nozzle 414 that defines the wall of nozzle 414. To illustrate this point, FIG. 4a shows nozzle 414 loaded with a discrete quantity of ejectant 433b via second orifice 419. Ejectant 433b occupies a portion of the interior volume of nozzle 414 adjacent to second surface 412 of body 410. Ejectant 433b is in contact with interior surface 414a of nozzle 414 that extends between first orifice 418 and second orifice 419 and defines the walls of the conduit connecting first orifice 418 and second orifice 419. FIG. 4b shows nozzle 414 at a time shortly after ejectant 433b has been ejected by pressurised gas, represented by arrow 479. Majority portion 433c of the ejectant is ejected from nozzle 414 by the pressurised gas. However, residual portion 433d of the ejectant remains adhered to internal surface 414a of nozzle 414 after majority portion 433c of the ejectant has been ejected. This may, for example, be due to an attractive or adhesive force between the ejectant and internal surface 414a of nozzle 414, for example electrostatic or other intramolecular forces, due to the viscosity of the ejectant, or due to the ejectant curing, setting, spoiling, drying, solidifying, or otherwise forming a residue on internal surface 414a of nozzle 414.

Residual ejectant 433d that remains within nozzle 414 after ejection of majority portion 433c of the ejectant can lead to a build-up of ejectant residue within nozzle 414 over an extended period of time after several filling and ejection cycles have been performed. This is more likely to occur when a component of the ejectant, typically a carrier component such as a solvent (when the ejectant is a solution) or a continuous-phase component (when the ejectant is an emulsion or suspension), evaporates, leaving behind the less-volatile components of the ejectant as a residue on internal surface 414a of the nozzle. For example, when the ejectant comprises or is a water-based glue or adhesive (e.g. polyvinyl acetate, or PVA, glue), evaporation of the water component of the glue or adhesive between successive ejection and nozzle filling steps results in the glue or adhesive drying to form an undesirable film on the inside of nozzle 414. Alternatively, the ejectant may cure, spoil, degrade, oxidise, or otherwise chemically alter with the passage of time to form a residue. For example, hot-melt glues or adhesives (i.e. adhesives comprising thermoplastic polymers and resins that are solid at room temperature and are applied in a molten form) may oxidise over time, eventually resulting in a residue forming. Other ejectants, whether water-based, solvent-based, oil-based or otherwise may also present a similar issue, resulting in a build-up of residue on the inside of nozzle 414. The build-up of residue within nozzle 414 may, over a long period of time, lead to nozzle 414 becoming clogged or otherwise blocked, requiring periodic maintenance of the fluid ejector, for example to clean the drum or exchange the drum for a residue-free drum.

Similarly, some ejectant may be deposited onto second surface 412 of the body when nozzle 414 is filled with ejectant via second orifice 419. Certain designs of ejectant supply assembly may, to at least some extent, reduce the amount of ejectant that remains on second surface 412 after nozzle 414 has been loaded with ejectant, for example by employing resilient seal member 332 as described above in relation to FIGS. 3a and 3b. Nevertheless, some ejectant may remain on second surface 412 after nozzle 414 is filled with ejectant via second orifice 419. Like residual ejectant 433d that remains in nozzle 414 after majority portion 433d of the ejectant has been ejected from nozzle 414, the residual ejectant left on second surface 412 after filling nozzle 414 can, over a long period of time, lead to a build-up of ejectant residue on second surface 412 of body 410. This may also negatively impact on the performance of the apparatus. The ejectant supply assemblies generally perform most effectively when second surface 412 remains clean and smooth, so build-up of ejectant residue on second surface 412 is to be avoided if possible.

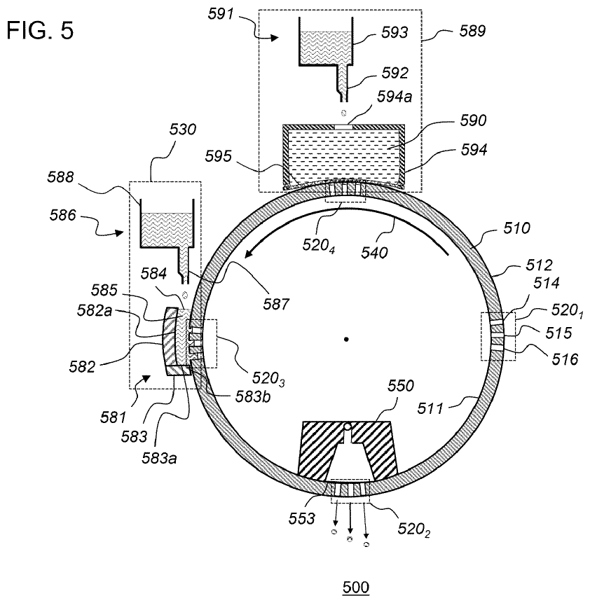

FIG. 5 shows a cross-sectional view of fluid ejector apparatus 500 in accordance with embodiments of the present disclosure that is intended to reduce ejectant residue build-up. Apparatus 500 is generally similar to apparatus 300 shown in FIGS. 3a and 3b, and, unless where otherwise disclosed, the configuration and operation of apparatus 500 may be assumed to be the same as that of apparatus 300.

Apparatus 500 comprises cylindrical or annular body 510 (also referred to as roller or drum) having a plurality of nozzle patterns 520₁-520₄ each comprising a plurality of nozzles 514, 515, 516, as described in relation to apparatus 300 shown in FIGS. 3a and 3b. The details and operation of drum 510 are the same as for drum 310 shown in FIG. 3 and are therefore not repeated.

Apparatus 500 also comprises a gas supply assembly comprising gas supply head 550 for supplying pressurised gas to the nozzles formed in drum 510 to effect ejection of ejectant loaded into the nozzles. Again, the details and operation of gas supply head 550 are the same as for gas supply head 350 shown in FIG. 3 and are therefore not repeated.

The apparatus 500 also comprises ejectant supply assembly 530 for supplying ejectant to the nozzles formed in drum 510. As described in further detail below, ejectant supply assembly 530 of apparatus 500 differs in structure from ejectant supply assembly 330 employed in apparatus 300, but its general functionality to supply ejectant to the nozzles formed in drum 510 remains the same.

Ejectant supply assembly 530 of apparatus 500 comprises filler 581 (which may also be referred to as ejectant guide, ejectant loader, or nozzle filler). Filler 581 is shaped or profiled to cooperate with second surface 512 of drum 510 when in use to define cavity or pocket 585 that defines an ejectant reservoir from which ejectant is supplied to nozzles 514, 515, 516 formed in drum 510. Filler 581 may be a device as described in WO 2020/193813 A1, the entire contents of which is incorporated herein by reference. Filler 581 shown in FIG. 5 has a substantially L-shaped cross-sectional profile that partially defines the ejectant reservoir when filler 581 is positioned adjacent to drum 510 when in use. As illustrated in FIG. 5, filler 581 may comprise first member 582 and second member 583. In apparatus 500 illustrated in FIG. 5, first member 582 and second member 583 are two separate parts (components), where first member 582 is attached (by any of several means known to those skilled in the art) to second member 583. However, first 582 and second 583 members may alternatively form a unitary body. Whether filler 581 is comprised of a unitary body or separate parts, filler 581 is generally of a rigid construction, in contrast to fillers 184, 284, 384 of apparatuses 100, 200, 300 shown in FIGS. 1a to 1c, 2, 3a and 3b, which comprise resilient seal member 132, 232 that is deformable.

First member 582 comprises internal, or body-facing, surface 582a that faces towards drum 510 during use. Internal or body-facing surface 582a may also be referred to as “upstream surface”. Second member 583 comprises internal surface 583a that forms an internal angle with internal surface 582a of first member 582, and body-facing surface 583b that faces towards drum 510 during use. Body-facing surface 583b of second member 583 may also be referred to as “downstream surface”. First 582 and second 583 members are connected such that internal surface 583a of second member 583 protrudes or extends from internal surface 582a of first member 582 towards drum 510. The internal surfaces of first 582 and second 583 members form an interior angle of approximately 90 degrees, thus creating an L-shaped cross-sectional profile. However, the cross-sectional profile may vary. For example, the interior angle between internal surfaces 582a, 583a of first 582 and second 583 members may take a value anywhere in the range from 20 degrees to 160 degrees, or in the range from 60 degrees to 120 degrees, or in the range from 80 degrees to 100 degrees. Internal surface 582a of first member 582 is also configured to be substantially parallel to the second surface of the nozzle-bearing body of the apparatus when in use. Since the body is in the form of rotatable annular drum 510 in apparatus 500 of FIG. 5, internal surface 582a of first member 582 is curved so that it is substantially concentric with second surface 512 of drum 510.

In the context of this disclosure, ‘substantially concentric’ shall be understood to include small deviations from concentricity such that the tangents to the cylindrical surface of the nozzle-bearing body and the upstream surface taken where they meet a common radial vector originating at the axis of the cylindrical material body shall form a small acute angle (less than or equal to 20 degrees). Similarly, ‘substantially parallel’ shall be understood to include small deviations from parallelism such that the planar surface of the upstream body and the planar surface of the nozzle-bearing body shall form a small acute angle (less than or equal to 20 degrees).

In the working configuration, filler 581 is positioned and held proximate to drum 510 (e.g., mechanically pressed against the drum 510) such that second member 583 protrudes toward second surface 512 of drum 510. In such a configuration, internal surface 582a of first member 582 and second surface 512 of drum 510 form a fluid-loading opening 584 for receiving fluid to be loaded into nozzles 514, 515, 516 of drum 510 via the second orifices of nozzles 514, 515, 516. A small gap may also be formed between body-facing or downstream surface 583b of second member 583 and second surface 512 of drum 510. In use, internal surface 582a of first member 582, internal surface 583a of second member 583 and second surface 512 of drum 510 cooperate to at least partially define the ejectant reservoir. As such, at least internal surfaces 582a, 583a of first 582 and second 583 members and second surface 512 of drum 510 come in contact with the ejectant within the ejectant reservoir, and each form a wall or internal surface of the ejectant reservoir.

Filler 581 may also comprise first and second side members (not shown) that protrude towards drum 510 from internal surface 582a of first member 582 to close off the ends of cavity 585 that defines the ejectant reservoir. This prevents the ejectant from spilling out from the sides of cavity 585 when cavity 585 is loaded with ejectant. Alternatively, internal surface 582a of first member 582 may be shaped so as to close off the ends of cavity 585 without the need for side members. For example, internal surface 582a of first member 582 may be shaped to form a recess therein.

In use, filler 581 is held or positioned so that as the nozzle-bearing body, in this case drum 510, moves relative to filler 581 so that nozzles 514, 515, 516 travel from the upstream end of filler 581 where fluid-loading opening 584 is located to the downstream end of filler 581 where second member 583 protrudes from first member 582. In the embodiment illustrated in FIG. 5, the upstream end of filler 581 is an upper end of filler 581, and the downstream end of filler 581 is a lower end of filler 581, and drum 510 rotates so that nozzles 514, 515, 516 travel from the upper end of filler 581 to the lower end of filler 581.

Ejectant supply assembly 530 further comprises ejectant feed assembly 586 (also referred to herein as ejectant feed) configured to supply ejectant to the ejectant reservoir. Ejectant feed assembly 586 comprises ejectant feed conduit 587, for example a nozzle, pipe, tube, or other conduit, through which ejectant is supplied to the ejectant reservoir from ejectant supply tank 588, which may either form a part of ejectant feed assembly 586, as shown in FIG. 5, or may be separate from ejectant feed assembly 586. Ejectant feed assembly 586 includes one or more valves or other flow control means (not shown) arranged to control the flow rate of ejectant supplied to the ejectant reservoir. In particular, the flow control means may be arranged to control the flow rate of the ejectant supplied to the ejectant reservoir to maintain an adequate or appropriate supply of ejectant within the ejectant reservoir to cause the desired amount of ejectant to be supplied to each of nozzles 514, 515, 516. The flow control means may thereby facilitate control of the amount of ejectant supplied to nozzles 514, 515, 516 by ejectant supply assembly 530. Ejectant supply assembly 530 is therefore able to supply discrete, metered quantities of ejectant to nozzles 514, 515, 516.

In use, due to the presence of protruding internal surface 583a of second member 583, the viscosity of the ejectant, and the relative motion between internal surface 582a of first member 582 and second surface 512 of drum 510, the ejectant experiences shear forces that cause the fluid pressure within the ejectant reservoir to increase in the direction from the upstream end of filler 581 to the downstream end of filler 581. This increase in fluid pressure causes ejectant within the ejectant reservoir to be pushed into nozzles 514, 515, 516 that are exposed to the ejectant reservoir as drum 510 rotates. As drum 510 rotates and nozzles 514, 515, 516 are loaded with ejectant the ejectant within the reservoir generally flows from the upstream end of the ejectant reservoir to the downstream end of the ejectant reservoir, hence the use of the terms “upstream” and “downstream” in the context of filler 581.

If second member 583 is not in contact with second surface 512 of drum 510 some of the ejectant may flow out through the terminal gap that exists at the downstream end of filler 581 between second surface 512 of drum 510 and body-facing surface 583b of second member 583. It is, however, generally desirable to keep to a practical minimum such discharge of fluid through the terminal gap since this ‘excess fluid’ does not carry the pattern of nozzles 514, 515, 516 that is ultimately desired to be deposited upon a final substrate and may leave a residue on second surface 512 of drum 510, as described previously.

Filler 581 illustrated in FIG. 5 is one embodiment of a shaped filler that may be incorporated into an apparatus in accordance with the embodiments of the present disclosure. Further configurations of filler are described in further detail in WO 2020/193813 A1, which is incorporated herein by reference in its entirety. In general, however, filler 581 may be configured so that, in use, it cooperates with nozzle-bearing body 510 to form or define an ejectant reservoir from which ejectant is supplied to nozzles 514, 515, 516 of nozzle-bearing body 510. Further, filler 581 is shaped so that, in use, movement of nozzle-bearing body 510 relative to filler 581 causes a positive pressure gradient to become established within the ejectant reservoir in a direction from an upstream end of the ejectant reservoir (to which nozzles 514, 515, 516 of nozzle-bearing body 510 are exposed first as nozzle-bearing body 510 and filler 581 move relative to each other) to a downstream end of the ejectant reservoir, thereby facilitating supply of ejectant into nozzles 514, 515, 516. Filler 581 may therefore have a substantially L-shaped profile, may, in cooperation with nozzle-bearing body 510 in use, define opening 584 at its upstream end via which the ejectant may be supplied to the ejectant reservoir from an ejectant feed.

Although ejectant supply assembly 530 of apparatus 500 illustrated in FIG. 5 comprises shaped ejectant filler 581, ejectant supply assembly 530 could instead be configured as described in relation to any of FIGS. 1a to 1c, 2, 3a and 3b. For example, the ejectant supply means may comprise an ejectant supply holder and at least one resilient member extending from the ejectant supply holder and configured to provide for pressure-bearing contact between the resilient member and one of the first and second surfaces of the body such that, in use, the resilient member guides the ejectant into the one or more nozzles. In some embodiments, in use the at least one resilient member is in pressure-bearing contact with the second surface of the body such that the resilient member guides the ejectant into the one or more nozzles through the respective second orifices. However the ejectant supply assembly is configured, the ejectant supply assembly generally supplies the ejectant to each of the one or more nozzles at a pressure above ambient pressure. The ejectant supply assembly is also preferably configured to permit control over the amount (either by weight or volume) of ejectant supplied to the nozzles. In other words, the ejectant supply assembly is preferably configured to supply a metered quantity or amount of ejectant to the nozzles when the apparatus is in use.

Apparatus 500 differs from the apparatuses shown in FIGS. 1a to 1c, 2, 3a and 3b in that it further comprises a barrier fluid supply means in the form of barrier fluid supply assembly 589 (also referred to herein as a barrier fluid supplier).

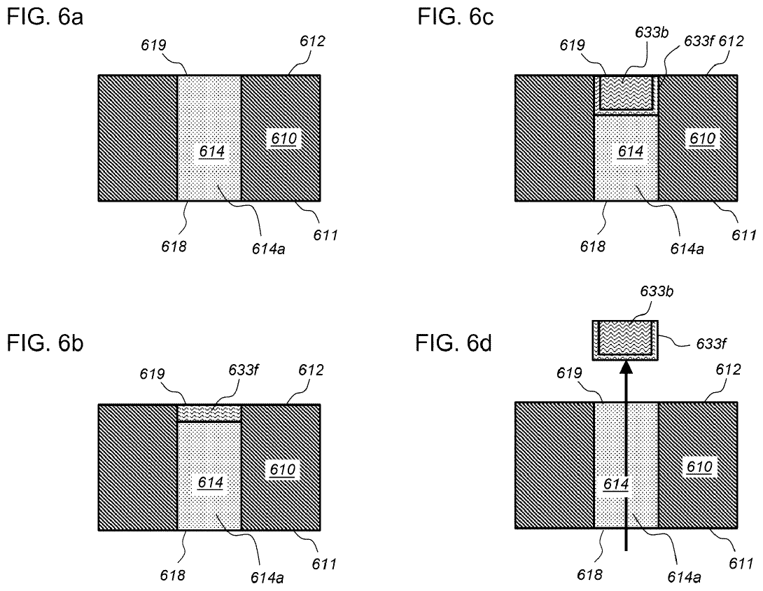

Barrier fluid supply assembly 589, which is described in further detail below, is configured to contact second surface 512 of drum 510 to supply barrier fluid to nozzles 514, 515, 516 formed in drum 510 via the second orifices of nozzles 514, 515, 516. More specifically, barrier fluid supply assembly 589 is arranged so that, in use, it supplies a discrete, and preferably metered, amount of barrier fluid to each of nozzles 514, 515, 516 prior to the ejectant being supplied to the nozzle by ejectant supply assembly 530. Once the ejectant has also been supplied to a nozzle by ejectant supply assembly 530, the barrier fluid at least partially coats the interior surface of the nozzle to form a barrier between the ejectant and the interior surface of the nozzle, thereby reducing contact of the ejectant with the interior surface of the nozzle. This process may be understood more fully with reference to FIGS. 6a to 6d.

FIG. 6a shows empty nozzle 614 prior to supply of either barrier fluid or ejectant. FIG. 6b shows nozzle 614 pre-loaded or pre-filled with a discrete quantity of barrier fluid 633f supplied from barrier fluid supply assembly 589. FIG. 6c shows nozzle 614 after a discrete quantity of ejectant 433b has also been supplied from ejectant supply assembly 530. In FIG. 6c nozzle 614 is loaded with both barrier fluid 633f and ejectant 633b, with barrier fluid 633f forming a barrier layer or coating on interior surface 614a of nozzle 614. In this way, barrier fluid 633f forms a barrier between the discrete quantity of ejectant 633b within nozzle 614 and interior surface 614a of nozzle 614, thereby reducing contact of ejectant 633b with interior surface 614a of nozzle 614. FIG. 6d shows nozzle 614 at a time shortly after ejectant 633b and barrier fluid 633f have been ejected by the pressurised gas, represented by arrow 679. Because barrier fluid 633f forms at least a partial barrier between ejectant 633b and interior surface 614a of nozzle 614 contact and/or adhesion of ejectant 633b to interior surface 614a of nozzle 614 is obstructed, and substantially all of the discrete quantity of ejectant 633b is ejected from nozzle 614 by the pressurised gas. In other words, barrier fluid 633f at least partially lines or coats interior surface 614a of nozzle 614 to facilitate a more complete ejection of ejectant 633b from nozzle 614. This may substantially prevent the build-up of ejectant residue within nozzle 614 over time. Furthermore, as barrier fluid 633 is ejected from nozzle 614 it may clean interior surface 614a of nozzle 614, which also may also reduce the build-up of ejectant residue within nozzle 614. Although FIG. 6d shows barrier fluid 633f being ejected together with ejectant 633b, in some embodiments barrier fluid 633f may be only partially ejected from nozzle 614 or may not be ejected from nozzle 614 in appreciable quantities. In other words, in some embodiments only some of, or substantially none of, barrier fluid 633f is ejected from nozzle 614 together with ejectant 633b, leaving some, or substantially all, of ejectant 633f, within nozzle 614 once ejectant 633b has been ejected.

The barrier fluid may therefore reduce the tendency of the nozzles to become blocked or clogged with ejectant residue, thereby reducing downtime of the apparatus for cleaning and reducing the frequency with which the nozzle-bearing body needs to be replaced or cleaned to ensure satisfactory performance of the fluid ejector.

The barrier fluid functions to at least partially pre-coat or line the nozzles, and may therefore alternatively be referred to as a nozzle coating fluid, a nozzle pre-coating fluid, or a nozzle lining fluid. Alternatively, it may be said that the barrier fluid forms an interfacial layer between the ejectant and the interior surface of the nozzle. The barrier fluid may therefore alternatively be referred to as an interfacial fluid.

Another perspective is that the barrier fluid serves to lubricate the nozzles because it reduces adhesion of the ejectant to the interior surface of the nozzles. The barrier fluid may therefore alternatively be referred to as a lubricating fluid, or a fluidic lubricant.

The barrier fluid may be any fluid that is capable of forming at least a partial barrier between the ejectant and the interior surface of the nozzles to reduce contact of the ejectant with the interior surface of the nozzles. The composition of the barrier fluid will, in general, depend on the composition of the ejectant, and the specific application to which the fluid ejector apparatus is employed. In the context of this disclosure, the term ‘barrier fluid’ encompasses flowable materials, or fluids, such as those materials whose constituent parts or sub-volumes are capable of relative motion, and includes, but is not limited to, liquids, liquid solutions, suspensions, emulsions, gels, waxes and oils. When the barrier fluid is in liquid form it may be referred to as a barrier liquid.

The barrier fluid may, for example, comprise a dominant component that is also a component of the ejectant. By “dominant component” it is meant a component that makes up at least 70% by weight of the barrier fluid, optionally at least 80% by weight of the barrier fluid, further optionally at least 90% by weight of the barrier fluid, yet further optionally at least 95% by weight of the barrier fluid. In other words, the barrier fluid may comprise the dominant component in an amount of at least 70% by weight, optionally in an amount of at least 80% by weight, further optionally in an amount of at least 90% by weight, yet further optionally in an amount of at least 95% by weight. Alternatively, barrier fluid may consist or consist essentially of the dominant component. In other words, the barrier fluid may consist, or consist essentially of, a substance that is also a component of the ejectant. The dominant component of the barrier fluid may, for example, be a carrier component (for example a solvent component or continuous-phase component) of the ejectant. When the ejectant is an aqueous or water-based fluid (i.e. when the ejectant comprises water, for example as a carrier component such as a solvent or continuous-phase component) the barrier fluid may also be an aqueous or water-based fluid, and the dominant component may be water. For example, the ejectant may be an aqueous or water-based solution, suspension, emulsion, or other mixture, and the barrier fluid may comprise water as a dominant component. In one particular example, the ejectant may be an aqueous glue or adhesive, such as a PVA glue, and the barrier fluid may comprise water as the dominant component, or may consist or consist essentially of water. When the barrier fluid and the ejectant are both aqueous or water-based fluids the barrier fluid effectively pre-wets the internal surfaces of the pores, which slows down the drying of the ejectant for long enough to prevent the ejectant from drying onto the inside surface of the nozzles.

When the barrier fluid comprises a dominant component that is also a component of the ejectant its effect on the ejectant is reduced because the amount of additional substances that are loaded into the nozzles together with the ejectant is minimised. This has the effect that the overall composition of the substances ejected by the fluid ejector remains similar to the case when only the ejectant is ejected from the nozzles. In such cases, the barrier fluid effectively dilutes the ejectant relative to the dominant component once the ejectant and the barrier fluid are ejected from the nozzles and deposited onto a substrate, and the effect of the barrier fluid on the ejectant is therefore primarily to increase the drying or curing time of the ejectant once it has been deposited onto the substrate. The barrier fluid also serves to dilute the ejectant around the periphery of the nozzle adjacent to the internal surface of the nozzle. Therefore, in such cases the barrier fluid may be termed a “diluent”.

More broadly speaking, the barrier fluid and the ejectant may comprise one or more components that are common to both the barrier fluid and the ejectant. In other words, the barrier fluid may comprise one or more components that are also components of the ejectant. These components may be referred to as “common components” as they are common to both the barrier fluid and the ejectant. That is, each of the barrier fluid and the ejectant comprise a respective amount of each of the common components. The one or more common components of the barrier fluid may be described in an analogous manner to the dominant component described above. For example, the barrier fluid may comprise the one or more common components in a total amount of 70% by weight of the barrier fluid, optionally at least 80% by weight of the barrier fluid, further optionally at least 90% by weight of the barrier fluid, yet further optionally in an amount of at least 95% by weight. Alternatively, barrier fluid may consist or consist essentially of the one or more common components. In other words, the barrier fluid may consist, or consist essentially of, one or more substances that are also components of the ejectant. The common components of the barrier fluid may, for example, be carrier components (for example solvent components or continuous-phase components) of the ejectant. Put another way, the barrier fluid may comprise at least 70% by weight, optionally at least 80% by weight, further optionally at least 90% by weight, yet further optionally 95% by weight of one or more substances that are carrier components of the ejectant. The one or more common components may comprise or consist of a dominant component, as described above.

Again, when the barrier fluid comprises one or more common components that are also components of the ejectant its effect on the ejectant is reduced because the amount of additional substances that are loaded into the nozzles together with the ejectant is minimised. This has the effect that the overall composition of the substances ejected by the fluid ejector remains similar to the case when only the ejectant is ejected from the nozzles. In other words, the barrier fluid effectively dilutes the ejectant relative to the common components once the ejectant and the barrier fluid are ejected from the nozzles and deposited onto a substrate, and the effect of the barrier fluid on the ejectant is therefore primarily to increase the drying or curing time of the ejectant once it has been deposited onto the substrate, particularly when the one or more common components are carrier components that evaporate from the ejectant to effect curing, setting or drying of the ejectant once it is applied to the substrate.

When the barrier fluid comprises water, optionally as the dominant component, the barrier fluid may further comprise a wetting agent, such as a surfactant. The inclusion of a wetting agent reduces the surface tension of the barrier fluid and results in a more effective coating of the interior surface of the nozzle by the barrier fluid. More generally, regardless of whether the barrier fluid comprises water, the barrier fluid may comprise a surface tension reducing agent, such as a surfactant, that reduces the surface tension of the barrier fluid. For example, if the barrier fluid is an oil-based fluid, the surface tension reducing agent may comprise a silicone surfactant.

In some circumstances it may be beneficial for the barrier fluid and the ejectant to be substantially miscible (i.e. may mix together to form a homogeneous mixture). This may be achieved by selecting the barrier fluid and the ejectant to both be of the same type or class of fluid. The type or class of fluid may be aqueous (e.g. water-based), oil-based, solvent-based, organic-based, polar, or non-polar. In particular, to achieve miscibility the barrier fluid and the ejectant may both be polar fluids or may both be non-polar fluids. For example, the barrier fluid and the ejectant may both be aqueous or water-based fluids or may both be oil-based fluids. An advantage of the barrier fluid being miscible with the ejectant is that once the ejectant and the barrier fluid are ejected from the nozzle and deposited onto a substrate the ejectant and the barrier fluid will mix together to form a homogeneous layer, which is desirable in certain situations, for example when the aim is to provide a uniform and consistent coating onto a substrate. If the barrier fluid and the ejectant are miscible the time between supplying the ejectant to a nozzle and ejecting the ejectant (and the barrier fluid) from the nozzle should be short enough to avoid substantial mixing of the barrier fluid and the ejectant within the nozzle.

Alternatively, in some circumstances it may be beneficial for the barrier fluid and the ejectant to be substantially immiscible (i.e. the barrier fluid and the ejectant may not mix together to form a homogeneous mixture). This may be achieved by selecting the barrier fluid and the ejectant to be of different types or classes of fluid that do not mix. Again, the type or class of each fluid may be aqueous or water-based, oil-based, solvent-based, organic-based, polar, or non-polar. In particular, to achieve immiscibility one of the barrier fluid and the ejectant may be a polar fluid and the other may be a non-polar fluid. For example, one of the barrier fluid and the ejectant may be an aqueous or water-based fluid and the other may be an oil-based fluid An advantage of the barrier fluid being immiscible with the ejectant is that the barrier fluid and the ejectant will not mix within the nozzle. This has may have the effect of maintaining the barrier layer formed by the barrier fluid, thereby substantially avoiding penetration of the barrier layer by the ejectant and further reducing contact of the ejectant with the interior surface of the nozzle. This approach may be best suited to applications in which the homogeneity of the coating formed on the substrate by the ejectant and the barrier fluid is unimportant.

When the ejectant is a hot-melt mixture, such as a hot-melt adhesive, the barrier fluid may be an oil-based fluid. An oil-based fluid will generally be better suited to the conditions, specifically the elevated temperatures, required to maintain the hot-melt fluid in molten form, and will be less likely to compromise the properties of the hot-melt mixture if the barrier fluid and the hot-melt mixture mix together to some degree.

In some embodiments the barrier fluid may reduce the frictional forces between the fluids within the nozzle and the interior surface of the nozzle as the ejectant is ejected from the nozzle compared to the case when the barrier fluid is not present. In other words, the barrier fluid may lubricate the interface between the ejectant and the interior surface of the nozzle, thereby facilitating ejection of the ejectant from the nozzles. The barrier fluid may therefore be referred to as a fluidic lubricant, a lubricating fluid, or a nozzle lubricant.

For example, in some embodiments the viscosity of the barrier fluid may be lower than the viscosity of the ejectant when measured under the same conditions (e.g. temperature, pressure and shear velocity or shear rate). Preferably, the conditions under which the barrier fluid has a lower viscosity than the ejectant are those experienced by the fluid within the nozzle as it is ejected from the nozzle. The conditions may, for example, be room temperature (e.g. 25° C.), atmospheric pressure (101325 Pa), and a shear rate of 100,000 s⁻¹ (the typical shear conditions experienced by a barrier fluid layer of 20 μm thickness when the ejectant is ejected at 2 m/s). Put another way, the barrier fluid may have a lower viscosity than the ejectant under the conditions experienced by the barrier fluid as the ejectant and the barrier fluid are ejected from the nozzle during operation of the apparatus, thereby reducing the frictional forces between the fluid within the nozzle and the interior surface of the nozzle as the ejectant is ejected from the nozzle compared to the case when the barrier fluid is not present. Using a barrier fluid that has a lower viscosity than the ejectant may thereby serve to lubricate the interior surface of the nozzle, resulting in a more effective and complete ejection of the ejectant from the nozzle. This, in turn, may reduce build-up of ejectant residue on the interior surfaces of the nozzles.

Alternatively, or additionally, in some embodiments the barrier fluid may have a lower force of adhesion, or force of attraction, to the interior surface of the nozzles than the ejectant. For example, if the interior surface of the nozzle has hydrophobic properties, the barrier fluid may be selected to be an aqueous liquid to provide low forces of attraction between the interior of the nozzle and the barrier fluid. Conversely, if the interior surface of the nozzle has hydrophilic properties, the barrier fluid may be selected to be an oil-based fluid. By lowering the forces of attraction between the fluid in contact with the interior surface of the nozzles the fluid within the nozzles may be more effectively, completely, or forcefully ejected from the nozzles, which may also reduce the build-up of ejectant residue within the nozzles.

Generally, whether the barrier fluid has a lower viscosity than the ejectant, or has a lower adhesion to the interior walls of the nozzles than the ejectant, the barrier fluid may at least partially line or coat the nozzles to facilitate more effective, complete, or forceful ejection of the ejectant from the nozzles. In other words, the ejection force required to eject the ejectant from the nozzles at a given velocity is reduced by the barrier fluid.

Although the barrier fluid forms at least a partial barrier between the ejectant and the interior surface of the nozzle, it is possible for at least some mixing of the barrier fluid and the ejectant to occur within the nozzle prior to ejection of the ejectant. Indeed, some degree of mixing will be largely inevitable, and will occur to a greater extent when the barrier fluid and the ejectant are miscible, for example when both the barrier fluid and the ejectant are aqueous fluids. In such cases the barrier fluid dilutes the ejectant around the periphery of the nozzle, and therefore still reduces contact and/or adhesion of the ejectant with the interior surface of the nozzle. The dilution of the ejectant by the barrier fluid may also increase the drying, setting or curing time of any residual (diluted) ejectant that remains within the nozzle after the ejection of the majority portion of the ejectant by the pressurised gas, reducing the tendency for a residue to form within the nozzle between filling and ejection cycles.

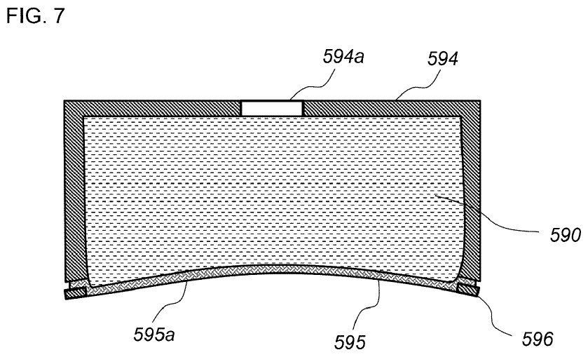

Referring again to FIG. 5, and also to FIG. 7, barrier fluid supply assembly 589 of apparatus 500 comprises porous absorbent medium 590 that acts as a barrier fluid reservoir. Absorbent medium 590 may, for example, comprise a sponge, either natural or synthetic, or another porous absorbent material.

Barrier fluid supply assembly 589 further comprises barrier fluid feed assembly 591 (also referred to herein as barrier fluid feed) configured to supply barrier fluid to absorbent medium 590. Barrier fluid feed assembly 591 comprises barrier fluid feed conduit 592 through which barrier fluid is supplied to the barrier fluid reservoir (i.e. absorbent medium 590 in FIG. 5) from barrier fluid supply tank 593. Barrier fluid feed assembly 591 includes one or more valves or other flow control means (not shown) arranged to control the flow rate of barrier fluid supplied to the barrier fluid reservoir. In particular, the flow control means may be arranged to control the flow rate of the barrier fluid supplied to the ejectant reservoir to maintain an adequate or appropriate supply of barrier fluid within the barrier fluid reservoir to cause the desired amount of barrier fluid to be supplied to each of nozzles 514, 515, 516. The flow control means may thereby facilitate control of the amount of barrier fluid supplied to nozzles 514, 515, 516 by barrier fluid supply assembly 589.

Barrier fluid supply assembly 589 further comprises housing 594 that houses absorbent medium 590. Housing 594 is typically made from a rigid material. Housing 594 has feed port 594a formed therethrough through which the barrier fluid is fed into the barrier fluid reservoir by barrier fluid feed assembly 591.

Barrier fluid supply assembly 589 further comprises contact layer 595 that overlays absorbent medium 590 and, in use, is positioned between absorbent medium 590 and second surface 512 of drum 510. In use, contact surface 595a of contact layer 595 contacts second surface 512 of drum 510 to effect supply of barrier fluid to nozzles 514, 515, 516 formed in drum 510 from the barrier fluid reservoir, which in this case is absorbent medium 590. Contact layer 595 is therefore typically formed from a porous or permeable material, such as a fabric, that permits the transfer of barrier fluid from absorbent medium 590 to nozzles 514, 515, 516 formed in drum 510. Contact layer 595 may be held in place by fixing collar 596 that is screwed or otherwise fixed to the underside of the housing so that a peripheral portion of contact layer 595 is held between the underside of housing 594 and fixing collar 596. Fixing collar 596 may have a substantially rectangular shape and may have a substantially rectangular aperture formed therethrough through which contact layer 595 is exposed to second surface 512 of drum 510. However, fixing collar 596 may have other shapes, as may the aperture formed therethrough.

In other embodiments, barrier fluid supply assembly 589 does not comprise contact layer 595. Instead, a contact surface of absorbent medium 590 contacts second surface 512 of drum 510 to effect supply of barrier fluid to nozzles 514, 515, 516 directly from absorbent medium 590. However, the provision of separate contact layer 595 allows the properties of absorbent medium 590 and of contact layer 595 to be selected to suit the different purposes of absorbent medium 590 and of contact layer 595. In particular, contact layer 595 permits the surface properties of contact surface 595a to be selected to facilitate a substantially uniform and consistent supply of barrier fluid to nozzles 514, 515, 516. For example, contact layer 595 may have a more uniform surface profile than absorbent medium 590, or may have a more uniform distribution and/or size of pores than absorbent medium 590. For example, the average (mean) pore separation or average (mean) pore diameter of contact layer 595 may be smaller than that of absorbent medium 590. Alternatively, or additionally, contact layer 595 may have a lower surface roughness than absorbent medium 590. The surface roughness may, for example, be the arithmetic average (mean) surface roughness, Ra. Contact layer 595 may alternatively, or additionally, be formed from a more robust material than absorbent medium 590 to better withstand the wear caused by contact with rotating drum 510 when in use. In general it is desirable for the contact surface of barrier fluid supply assembly 589 to be robust, non-shedding, non-scratching, non-abrasive, readily wettable by the barrier fluid, permeable to the barrier fluid, and capable of transporting the barrier fluid in three dimensions. Contact layer 595 may therefore have one or more of these characteristics.

Contact layer 595 may be formed from a fabric, which may be a woven or a non-woven fabric. For example, the fabric may comprise polyester and may be a polyester fabric. Alternatively, contact layer 595 may be formed from a chamois, which may either be natural or synthetic. If a synthetic chamois is used, this may also be a non-woven fabric. Fabric and chamois materials generally provide a relatively uniform and hard-wearing porous surface, and are therefore well-suited for use as contact layer 595.

In use, barrier fluid supply assembly 589 is held in contact with drum 510 and barrier fluid is supplied to the barrier fluid reservoir (i.e. to absorbent medium 590) by barrier fluid supply assembly 589. Drum 510 is rotated about its axis by auxiliary means (not shown), for example, in the anticlockwise direction shown by directional arrow 540. As drum 510 rotates, so do each of nozzle patterns 520₁-520₄, and thus nozzles 514, 515, 516 of each of nozzle patterns 520₁-520₄ successively passes, and is exposed to, barrier fluid supply assembly 589, which supplies barrier fluid into nozzles 514, 515, 516 within patterns 520₁-520₄. As drum 510 rotates, the portions of second surface 512 of drum 510 in which nozzle patterns 520₁-520₄ are formed come into contact with barrier fluid supply assembly 589, which supplies barrier fluid into nozzles within patterns 520₁-520₄ as a result of said contact. The supply of barrier fluid to nozzles 514, 515, 516 from barrier fluid supply assembly 589 is assisted by gravity due to barrier fluid supply assembly 589 contacting an upward-facing portion of second surface 512 of drum 510. However, other arrangements are possible in which barrier fluid supply assembly 589 does not contact an upward-facing portion of second surface 512 of drum 510.

In use, absorbent medium 590 absorbs the barrier fluid supplied by barrier fluid feed assembly 591 and distributes the barrier fluid across contact surface 595a of barrier fluid supply assembly 589. Absorbent medium 590, and therefore the barrier fluid reservoir, may therefore, in use, extend across at least the width (in the axial direction of the drum) of nozzle patterns 520₁-520₄. Absorbent medium 590 may therefore facilitate a substantially uniform and controlled supply of relatively small quantities of barrier fluid to nozzles 514, 515, 516. This is because the saturation of absorbent medium 590 can be controlled by controlling the flow rate of barrier fluid supplied to absorbent medium 590. This, in turn, provides a high degree of control over the amount of barrier fluid that is supplied to nozzles 514, 515, 516. For example, by supplying a relatively low flow rate of barrier fluid to absorbent medium 590 the degree of saturation of absorbent medium 590 may be kept low, resulting in relatively low quantities of barrier fluid being supplied to nozzles 514, 515, 516. Furthermore, absorbent medium 590 is able to distribute relatively low quantities of barrier fluid substantially uniformly over second surface 512 of drum 510 via capillary action within absorbent medium 590. Barrier fluid supply assembly 589 is therefore able to supply discrete, metered quantities of barrier fluid to each of nozzles 514, 515, 516.

Contact surface 595a of barrier fluid supply assembly 589, whether a surface of contact layer 595 or a surface of absorbent medium 590, preferably contacts second surface 512 of drum 510 across at least the width (in the axial direction) of nozzle patterns 520₁-520₄ formed in drum 510 to effect supply of barrier fluid to each of nozzles 514, 515, 516 of nozzle patterns 520₁-520₄. More generally, barrier fluid supply assembly 589 may be configured such that it is able to supply barrier fluid to nozzles 514, 515, 516 of drum 510 across a width of drum 510 in the axial direction corresponding to at least the width of nozzle patterns 520₁-520₄.

In other embodiments, barrier fluid supply assembly 589 may have a structure that is essentially the same as the ejectant supply assembly shown in any of FIG. 1a to 1c, 2, 3a, 3b, or 5. However, whereas the ejectant supply assemblies of FIG. 1a to 1c, 2, 3a, 3b, or 5 supply ejectant to the nozzles the barrier fluid supply assembly supplies barrier fluid to the nozzles. Therefore, whereas the ejectant supply assemblies of FIG. 1a to 1c, 2, 3a, 3b, or 5 are configured to handle ejectant, the barrier fluid supply assembly will be configured to handle barrier fluid. For example, barrier fluid supply assembly 589 may comprise a filler that is shaped to cooperate with second surface 512 of the body when in use to define a cavity or pocket that defines the barrier fluid reservoir, analogous to filler 581 of ejectant supply assembly 530 of fluid ejector 500 shown in FIG. 5. In such cases, the filler may be referred to as a barrier fluid guide, a barrier fluid loader, or a nozzle filler. Other configurations of barrier fluid supply assembly are also possible. For example, the barrier fluid supply assembly may comprise a dual-blade doctor blade chamber, a single-blade doctor blade chamber, a squeegee, or a reverse-roll coater for supplying barrier fluid to the nozzles. In some embodiments, the barrier fluid supply assembly comprises an application roller having an outer surface (or applicator surface) that may be loaded with barrier fluid in use. For example, the outer surface may be an absorbent surface (e.g. it may comprise an absorbent material) for absorbing barrier fluid. In use, the outer surface of the application roller contacts a surface of the nozzle-bearing body to supply barrier fluid to the nozzles. The application roller may rotate such that, where the outer surface of the application roller contacts the body, the outer surface of the application roller and the surface of the body that it contacts move at different velocities, either in the same direction or in different (e.g. opposite) directions. In the case where the body is an annular shape, such as a drum or a roller, the outer surface of the application roller and the surface of the body that it contacts may move at different angular velocities, and may rotate in either the same or the opposite direction or sense. For example, the application roller and the annular body may rotate in opposite directions, or in the opposite sense, to operate as a reverse-roll coater. This causes the application roller to wipe the surface of the body that it contacts. This wiping motion may serve to enhance the cleaning of the surface of the body by the application roller. The barrier fluid supply assembly may further comprise an application roller cleaning assembly for cleaning the application roller in use as the application roller rotates. For example, the barrier application roller cleaning assembly may comprise a doctor blade for scraping the outer surface of the application roller, or a jet washer directed at the outer surface of the doctor blade. The application roller cleaning assembly removes residue from the outer surface of the application roller, mitigating against build-up of residue and helping to ensure consistent application of barrier fluid and consistent cleaning of the nozzle-bearing body.

The amount of barrier fluid supplied to nozzles 514, 515, 516 may be affected by speed of rotation of drum 510, the time nozzles 514, 515, 516 are exposed to barrier fluid supply assembly 589, the diameter of nozzles 514, 515, 516, the dimensions of contact surface 595a (in particular its length in the circumferential direction), the material from which contact surface of the barrier fluid supply assembly (e.g. contact surface 595a or contact layer 595) is made, the contact pressure of the contact surface of barrier fluid supply assembly 589 on drum 510, and the flow rate of the barrier fluid fed into the barrier fluid reservoir by barrier fluid feed assembly 591. However, for a given set up, the amount of barrier fluid supplied to nozzles 514, 515, 516 by barrier fluid supply assembly 589 may primarily be controlled by controlling the flow rate of the barrier fluid fed into to the barrier fluid reservoir by barrier fluid feed assembly 591. This is because the amount of barrier fluid supplied to nozzles 514, 515, 516 by barrier fluid supply assembly 589 depends on the level of saturation of absorbent medium 590 with barrier fluid. The more saturated is absorbent medium 590 with barrier fluid the more barrier fluid is supplied to nozzles 514, 515, 516. Initially, barrier fluid that is supplied to absorbent medium 590 progressively increases the saturation level of absorbent medium 590 with barrier fluid. Some of the barrier fluid supplied to absorbent medium 590 will be supplied to the nozzles 514, 515, 516, optionally via contact layer 595. After an initial period in which the saturation level of absorbent medium 590 increases absorbent medium 590 will reach a level of barrier fluid saturation such that the amount of barrier fluid supplied to nozzles 514, 515, 516 from absorbent medium 590 is equal to the amount of barrier fluid supplied to absorbent medium 590 by barrier fluid feed assembly 591. At this point a steady state is reached, and the amount of barrier fluid supplied to nozzles 514, 515, 516 is equal to the amount of barrier fluid supplied to absorbent medium 590. The amount of barrier fluid supplied to nozzles 514, 515, 516 may be increased by increasing the flow rate of the barrier fluid fed into to the barrier fluid reservoir by barrier fluid feed assembly 591, and may be decreased by decreasing the flow rate of the barrier fluid fed into to the barrier fluid reservoir by barrier fluid feed assembly 591. Each time the flow rate of the barrier fluid is increased or decreased there will be a transition period before the saturation level of absorbent medium 590 reaches a steady state in which the amount of barrier fluid supplied to nozzles 514, 515, 516 from absorbent medium 590 is equal to the amount of barrier fluid supplied to the absorbent medium by barrier fluid feed assembly 591. Additionally, in order to ensure adequate contact of barrier fluid supply assembly 589 with second surface 512 of drum 510 and to provide further control over the amount of barrier fluid that is supplied to nozzles 514, 515, 516 by barrier fluid supply assembly 589 a displacement of barrier fluid supply assembly 589 relative to drum 510 may be adjustable so that the pressure applied to second surface 512 of drum 510 is adjustable. In particular, the displacement of barrier fluid supply assembly 589 in a direction normal to second surface 512 of drum 510 may be adjustable. Apparatus 500 may therefore further comprise a mounting assembly (not shown) upon which barrier fluid supply assembly 589 is mounted, the mounting assembly being configured to permit adjustment of a displacement of barrier fluid supply assembly 589 relative to drum 510.

In general, barrier fluid supply assembly 589 is preferably configured to permit control over the amount (either by weight or volume) of barrier fluid supplied to nozzles 514, 515, 516. In other words, barrier fluid supply assembly 589 is preferably configured to supply a metered quantity or amount of barrier fluid to nozzles 514, 515, 516.

The optimal amount of barrier fluid that should be supplied to each of nozzles 514, 515, 516 to form an effective barrier layer between the interior surface of the nozzle and the ejectant will depend on a variety of factors, including the composition of the barrier fluid, the composition of the ejectant, the size of nozzles 514, 515, 516, and the time between supplying the ejectant the nozzles 514, 515, 516 and ejecting the ejectant from nozzles 514, 515, 516. However, an effective barrier layer may generally be formed when the amount by volume of barrier fluid supplied to a nozzle is 5 to 40% of the total amount by volume of ejectant and barrier fluid supplied to that nozzle. More preferably, the amount by volume of barrier fluid supplied to a nozzle may be 10 to 30% of the total amount by volume of ejectant and barrier fluid supplied to that nozzle. Generally, the densities of the ejectant and the barrier fluid will be sufficiently similar that the amount of barrier fluid relative to ejectant may be expressed as an amount by weight rather than as an amount by volume as it could be easier to implement measuring weight fractions than volume fractions. These ratios have been found to be particularly applicable when both the ejectant and the barrier fluid are aqueous or water-based fluids, such as when the ejectant is a water-based PVA glue and the barrier fluid comprises water as the dominant component. These ratios have also been found to be particularly applicable when the diameter of the nozzles is in the range of 0.5 to 1 mm, for example 0.6 to 0.8 mm. These ratios have been found to be sufficient to form an effective barrier layer while limiting the influence of the barrier fluid on the ejectant, for example avoiding undue dilution of the ejectant by the barrier fluid. Generally, optimisation of the amount of barrier fluid that is supplied to nozzles 514, 515, 516 is a single parameter optimisation process. The process generally involves performing a series of test runs in which the amount of barrier fluid is progressively increased. Once it is observed that nozzles 514, 515, 516 no longer become blocked with ejectant residue it can be determined that the minimum acceptable amount of barrier fluid has is being supplied to nozzles 514, 515, 516.

Continued rotation of drum 510 in rotation direction 540 successively exposes each of nozzle patterns 520₁-520₄ to ejectant supply assembly 530, which supplies ejectant to nozzles 514, 515, 516 of each of nozzle patterns 520₁-520₄, as described previously.

Further rotation of drum 510 in rotation direction 540 brings each of nozzle patterns 520₁-520₄ successively underneath gas supply head 550, thereby exposing nozzles 514, 515, 516 of each of nozzle patterns 520₁-520₄ to the pressurised gas supplied from gas outlet 553 of gas supply head 550, as described previously in relation to the apparatuses of FIGS. 1a to 1c, 2, 3a and 3b. This results in ejection of the ejectant and, typically, at least some of the barrier fluid from nozzles 514, 515, 516 of the nozzle patterns, again as described in relation to the fluid ejectors shown in FIGS. 1a to 1c, 2, 3a and 3b.

In use, drum 510 rotates continuously so that each nozzle 514, 515, 516 undergoes a series of filling and ejection cycles. Each filling and ejection cycle includes a barrier fluid supply step, an ejectant supply step, and an ejection step. Each barrier fluid supply step involves rotating drum 510 to expose the second orifice of nozzle 514, 515, 516 to barrier fluid supply assembly 589 to supply barrier fluid to nozzle 514, 515, 516 via the second orifice of nozzle 514, 515, 516. Each ejectant supply step involves rotating drum 510 further to expose the second orifice of nozzle 514, 515, 516 to ejectant supply assembly 530 to supply ejectant to nozzle 514, 515, 516 via the second orifice of nozzle 514, 515, 516. Each ejection step involves rotating drum 510 further to expose the first orifice of nozzle 514, 515, 516 to the gas supply assembly to supply pressurised gas to nozzle 514, 515, 516 via the first orifice of nozzle 514, 515, 516 to cause ejection of the ejectant, and typically also at least some of the barrier fluid, from the second orifice of nozzle 514, 515, 516.

If the nozzle-bearing body of the apparatus is not a drum, for example if the an embodiment of the present disclosure is implemented by adding a barrier fluid supply apparatus to an apparatus that incorporates a plate-type body as illustrated in FIGS. 1a to 1c, then the rotation of drum 510 in each of the steps of the filling and ejection cycles is substituted by movement of the body relative to barrier fluid supply assembly 589, the ejectant supply assembly and the gas supply assembly, as applicable.

In some embodiments, the barrier fluid is selected so that it has sufficient adhesion to the interior surface of nozzles 514, 515, 516 or has a sufficiently high viscosity that it is not fully ejected by the pressurised gas supplied from the gas supply assembly. In such cases, a substantial portion of, for example substantially all of, the discrete portion of barrier fluid supplied to the nozzle by barrier fluid supply assembly 589 may remain within nozzle 514, 515, 516 even after the ejectant has been ejected by the pressurised gas, for example as a barrier layer deposited on the interior surface of nozzle 514, 515, 516. In such cases the barrier fluid supply step need not be performed in each and every filling and ejection cycle. For example, a barrier fluid supply step may be performed in a first filling and ejection cycle for each nozzle, whereafter a plurality of subsequent filling and ejection cycles do not include a barrier fluid supply step. Further barrier fluid supply steps may then be performed as required to replenish the barrier fluid as it is gradually ejected from the nozzle in the filling and ejection cycles that do not include a barrier fluid supply step. This may be achieved by moving barrier fluid supply assembly 589 so it is not in contact with drum 510 during the filling and ejection steps that do not require a barrier fluid supply step and moving barrier fluid supply assembly 589 so it is in contact with drum 510 during the filling and ejection steps that do require a barrier fluid supply step. When barrier fluid supply assembly 589 so it is not in contact with drum 510 the feed of barrier fluid to absorbent medium 590 may be stopped so that the saturation of absorbent medium 590 remains constant.

In addition to supplying nozzles 514, 515, 516 with barrier fluid, barrier fluid supply assembly 589 may also clean or otherwise remove residue from second surface 512 of drum 510 through contact with second surface 512 of drum 510. For example, the contact surface (e.g. contact surface 595a of contact layer 595) of barrier fluid supply assembly 589 may contact second surface 512 of drum 510 to clean residue from second surface 512 of drum 510. Barrier fluid supply assembly 589 may clean ejectant from second surface 512 of drum 510 that has been deposited on drum 510 by ejectant supply assembly 530, for example in a previous filling and ejection cycle. This cleaning of second surface 512 of drum 510 reduces the build-up of ejectant residue on second surface 512 of drum 510, which may otherwise adversely affect the performance of the apparatus, as explained previously.

Both absorbent medium 590 (e.g. a sponge) and contact layer 595 (e.g. a fabric layer) provide effective cleaning of second surface 512 of drum 510, particularly when loaded with the barrier fluid. However, the provision of contact layer 595 allows the properties of contact surface 959a to be selected to provide effective cleaning of second surface 512 of drum 510. The properties of the contact surface that provide for effective cleaning of second surface 512 of drum 510 are generally similar to the properties that provide for effective and uniform supply of barrier fluid to nozzles 514, 515, 516 discussed previously. For example, a uniform surface profile and a low surface roughness both facilitate effective cleaning of second surface 512 of drum 510.

Alternatively, or additionally, the apparatus may comprise a cleaning assembly separate from barrier fluid supply assembly 589 to clean residue from second surface 512 of drum 510. If present, cleaning assembly may also be configured to contact second surface 512 of drum 510 when in use to clean residue from second surface 512 of drum 510. The cleaning assembly may be configured similarly to barrier fluid supply assembly 589, but instead of barrier fluid being supplied by feed assembly 591, feed assembly 591 may instead supply cleaning fluid to absorbent medium 590 or the reservoir. Alternatively, the cleaning assembly may comprise a resilient seal member, or wiper blade, configured to contact second surface 512 of drum 510 in use to clean residue from second surface 512 of drum 510 as drum 510 rotates. If a separate cleaning assembly is present it is typically configured to clean second surface 512 of drum 510 between the ejection and barrier fluid supply steps.

In the process of supplying nozzles 514, 515, 516 with barrier fluid barrier fluid supply assembly 589 may also deposit barrier fluid onto second surface 512 of drum 510. For example, barrier fluid supply assembly 589 may deposit a film or coating of barrier fluid on second surface 512 of drum 510. This film or coating of barrier fluid forms a barrier between the ejectant supplied by ejectant supply assembly 530 and second surface 512 of drum 510, thereby reducing contact and/or adhesion of the ejectant to second surface 512 of drum 510. This reduces the build-up of ejectant residue on second surface 512 of drum 510 and assists in cleaning the ejectant from the surface of drum 510, for example by barrier fluid supply assembly 589.

Barrier fluid supply assembly 589 may therefore provide multiple functionalities that each serve to reduce or eliminate the build-up of ejectant residue within nozzles 514, 515, 516 and on the surface of drum 510. Barrier fluid supply assembly 589 of apparatus 500 is particularly well suited to performing the above-described functions, but other barrier fluid supply assembly configurations are also possible.

Fluid ejection apparatus in accordance with embodiments of the present disclosure may be employed to apply ejectant onto a substrate. The substrate may be a sheet material, such as paper, fabric, wooden board (e.g. medium density fibreboard (MDF) board), or other nonwoven or woven sheet material. The sheet material may be rigid or flexible. Alternatively, the substrate may be the surface of an object, such as a paper-based container. As such, the apparatus may further comprise a conveyor assembly configured to convey a substrate through a coating region in which ejectant ejected from nozzles 514, 515, 516 by the gas supply assembly is directed towards, and deposited on, the substrate. The conveyor assembly may, for example, comprise a conveyor belt upon which the substrate is conveyed through the coating region. Alternatively, for example when the substrate is a sheet material, such as paper or a fabric, the conveyor assembly may comprise a plurality of rollers for guiding the substrate through the coating region.

Fluid ejection apparatus in accordance with embodiments of the present disclosure may be used to apply a pattern of ejectant onto a substrate, for example a series of discrete dots, each corresponding to ejection of ejectant from one of the nozzles formed in the nozzle-bearing body. In other applications, fluid ejection apparatus in accordance with embodiments of the present disclosure may be used to apply a continuous coating of ejectant to a substrate. In such applications drum 510 may have a substantially continuous pattern of nozzles 514, 515, 516 extending around the entire circumference of drum 510, with nozzles 514, 515, 516 spaced sufficiently close together to provide a continuous coating of ejectant on the substrate.

Although embodiments of the present disclosure have been described above in the context of the barrier fluid being supplied to the nozzles via the second orifices of the nozzles, it is possible to instead supply the barrier fluid to the nozzles via the first orifices of the nozzles, for example from the inside surface of drum 510. Therefore, instead of contacting second (e.g. outer) surface 512 of drum 510 (or other form of nozzle-bearing body) barrier fluid supply assembly 589 may contact first surface 511 of drum 510 and may supply the barrier fluid to nozzles 514, 515, 516 via the first orifices formed in first surface 511. Therefore, more generally, barrier fluid supply assembly 589 may be said to supply the barrier fluid to each nozzle via a supply orifice of the nozzle, where the supply orifice may be either the first orifice or the second orifice of the nozzle, and barrier fluid supply assembly 589 may contact the surface of the body in which the supply orifice is formed.

It is further possible for the barrier fluid to be supplied to the nozzles via both the first and second orifices of the nozzles, for example from both the inside and outside surfaces of drum 510. In such embodiments, the fluid ejection apparatus may comprise one or more barrier fluid supply assemblies configured to supply barrier fluid to each of the nozzles via first and second orifices of the nozzles. For example, the fluid ejection apparatus may comprise a first barrier fluid supply assembly for supplying barrier fluid to each of the nozzles via their first orifices and a second barrier fluid supply assembly for supplying barrier fluid to each of the nozzles via their second orifices. In drum-based embodiments, the first barrier fluid supply assembly 589 may contact first surface 511 of drum 510 and may supply the barrier fluid to nozzles 514, 515, 516 via the first orifices formed in first surface 511, and the second barrier fluid supply assembly 589 may contact second surface 512 of drum 510 and may supply the barrier fluid to nozzles 514, 515, 516 via the second orifices formed in first surface 511. In such embodiments the ejectant is still typically supplied through the second orifices of the nozzles, e.g. from the outside surface of the drum. Supply of barrier from both sides of the drum may improve the cleaning abilities of the barrier fluid. For example, the additional supply of barrier fluid into the nozzles via the first orifices results in a more substantial quantity of barrier fluid being disposed in the nozzle “behind” the ejectant as a plug. On ejection of the ejectant and barrier fluid from the nozzle, this plug follows the ejectant out of the nozzle, effectively cleaning the nozzle of ejectant residue as it does so. Furthermore, the barrier fluid may serve to clean the first (e.g. inside) surface of the body in which the nozzles are formed, providing further benefits.

Although embodiments of the present disclosure have been described above in the context of the body moving (e.g. drum 510 rotating) and the barrier fluid supply assembly, the ejectant supply assembly and the gas supply assembly remaining stationary, it is possible for the relative movement of the body relative to the barrier fluid supply assembly, the ejectant supply assembly and the gas supply assembly to result from movement of the barrier fluid supply assembly, the ejectant supply assembly and the gas supply assembly while the body remains stationary.

Although embodiments of the present disclosure have been described above in the context of the ejectant being ejected from the nozzles by pressurised gas supplied from a gas supply assembly, it is alternatively possible for the ejectant to be ejected from the nozzle by an alternative ejection force. For example, the ejectant may carry a charge, and the ejection of the ejectant from the nozzles may be caused by an electrostatic force being imparted to the ejectant by one or more electrodes. The one or more electrodes may, for example, be configured to provide a pulsatile ejection force to the ejectant. Therefore, in the context of embodiments of the present disclosure, the gas supply assembly may be replaced by a different sort of ejector, such as an electrostatic ejector comprising one or more electrodes.

FIG. 5 illustrates an exemplary embodiment of a fluid ejector apparatus in accordance with embodiments of the present disclosure. Various alternative configurations are possible. For example, in accordance with embodiments of the present disclosure a fluid ejector apparatus may be configured essentially as shown in any of FIGS. 1a to 1c, 2, 3a and 3b, with the addition of a barrier fluid supply assembly. It is also possible to combine various aspects of each of the fluid ejectors disclosed herein, whether disclosed in relation to the apparatuses shown in any of FIGS. 1a to 1c, 2, 3a and 3b or specifically in relation to embodiments of this disclosure. For example, a fluid ejector in accordance with embodiments of this disclosure may comprise a barrier fluid supply assembly configured as shown in FIG. 5 with an ejectant supply assembly configured as shown in FIGS. 1a to 1c. In general, unless otherwise indicated and insofar as the resulting combinations are technically compatible, it is possible to take a component part from one of the fluid ejectors disclosed herein and combine this with another component part from a different fluid ejector disclosed herein. Generally, the functional component parts of apparatus 500 shown in FIG. 5 may be configured as described in relation to any of the apparatuses shown in FIGS. 1a to 1c, 2, 3a and 3b. For example, the nozzle-bearing body, the ejectant supply assembly, and/or the gas supply assembly may be configured as described in relation to any of the embodiments shown in FIGS. 1a to 1c, 2, 3a and 3b.

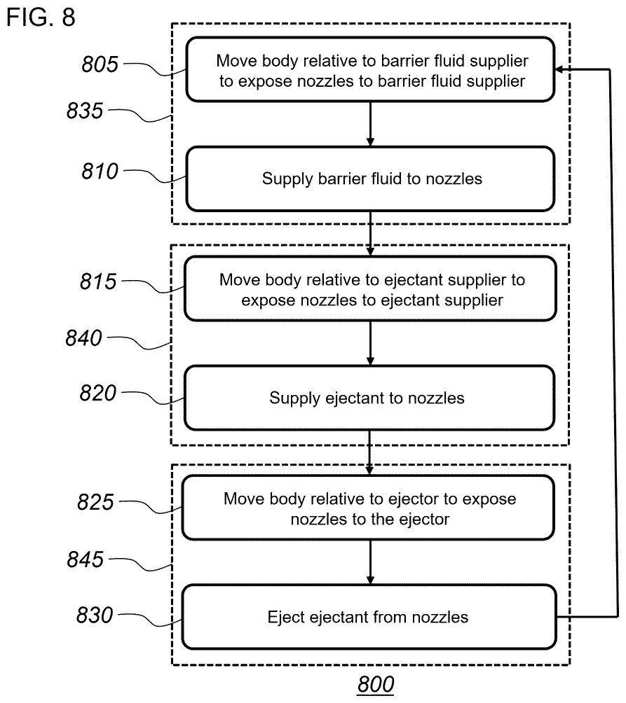

FIG. 8 shows a flow-diagram of a method 800 for dispensing flowable materials (ejectant), for example onto a substrate, according to some embodiments. Method 800 may be performed using an ejector having a plate-based nozzle-bearing body, such as described with reference to FIGS. 1a to 1c, or a drum-based nozzle-bearing body, such as described with reference to FIG. 5.

At step 805, the body is moved relative to the barrier fluid supply assembly to expose a supply orifice of each of one or more nozzles formed in the body to the barrier fluid supply assembly. Relative movement of the body with respect to the barrier fluid supply assembly may be caused by movement of the body while the barrier fluid supply assembly remains stationary, as in FIG. 5, or may be caused by movement of the barrier fluid supply assembly while the body remains stationary. The supply orifice of each nozzle may be the first orifice formed in the first surface of the body or the second orifice formed in the second surface of the body. More typically, the supply orifice is the second orifice.

At step 810 barrier fluid is supplied to each of the one or more nozzles via the supply orifice of each of the one or more nozzles by the barrier fluid supply assembly. In particular, a discrete, and optionally metered, quantity of barrier fluid may be supplied to each of the one or more nozzles.

At step 815 the body is moved relative to the ejectant supply assembly to expose the second orifice of each of the one or more nozzles to the ejectant supply assembly. Relative movement of the body with respect to the ejectant supply assembly may be caused by movement of the body while the ejectant supply assembly remains stationary, as in FIGS. 1a to 1c, 3a, 3b and 5, or may be caused by movement of the barrier fluid supply assembly while the body remains stationary, as in FIG. 2.

At step 820 ejectant is supplied to each of the one or more nozzles via the second orifice of each of the one or more nozzles from the ejectant supply assembly. In particular, a discrete, and optionally metered, quantity of ejectant may be supplied to each of the one or more nozzles.

At step 825 the body is moved relative to the ejector to expose the one or more nozzles to the ejector. For example, when the ejector is a gas supply assembly, step 825 may comprise moving the body relative to the gas supplier to expose the first orifice of each of the one or more nozzles to the gas supply assembly. Again, relative movement of the body with respect to the ejector may be caused by movement of the body while the ejector remains stationary, as in FIGS. 1a to 1c, 3a, 3b and 5, or may be caused by movement of the gas supply assembly while the body remains stationary.

At step 830 at least some of the ejectant is ejected from the second orifice of each of the one or more nozzles by an ejection force imparted to the ejectant in the one or more nozzles by the ejector. At least some of the barrier fluid may also be ejected from the second orifice of each of the one or more nozzles in step 830. When the ejector is a gas supply assembly, step 830 may comprise supplying pressurised gas to each of the one or more nozzles via the first orifice of each of the one or more nozzles to cause ejection of the at least some of the ejectant from the second orifice of each of the one or more nozzles.

The one or more nozzles referred to in the context of method 800 may be a single nozzle, or may be the nozzles of one or more patterns of nozzles formed in the nozzle-bearing body. Alternatively, the one or more nozzles may form at least a part of a nozzle pattern formed in the nozzle-bearing body. Method 800 may be performed for the nozzles of each of a plurality of nozzle patterns, or part nozzle patterns, formed in the nozzle-bearing body. For example, the nozzle-bearing body may be a drum that comprises a single nozzle pattern that extends around the entire circumference of the drum, and method 800 may be performed for each of a plurality of parts of the nozzle pattern, so that all of the parts of the nozzle pattern undergo the steps of method 800.

The steps of method 800 represent a single filling and ejection cycle. The steps of the method 800 may be repeated in a continuous manner to perform a series of filling and ejection cycles to apply a substantially continuous coating of ejectant to a substrate. For example, when the nozzle-bearing body is a rotatable drum such as drum 510 shown in FIG. 5 the drum may be continuously rotated so that each nozzle undergoes a series of filling and ejection cycles on a continuous basis. Within each filling and ejection cycle, the one or more nozzles may each undergo barrier fluid supply step 835, comprising steps 805 and 810 of method 800, ejectant supply step 840, comprising steps 815 and 820 of method 800, and ejection step 845, comprising steps 825 and 830 of method 800.

As described above, the method 800 is applicable in the context of plate and drum nozzle-bearing bodies. To repeat the steps of the method 800 in the context of the plate-based geometry, reciprocating motion of the moving components used. To repeat the steps of method 800 in the context of the drum-based geometry, a continuous rotation of the drum is used.

Method 800 is adaptable to embodiments in which there is no relative movement between the nozzles and the gas supply assembly (or other ejector). In these embodiments, step 825 of moving the body relative to the ejector is omitted. It may, for example, be advantageous to connect a gas supply to the first orifice of each of the nozzles and to use a pulsatile source of pressurised gas to cause ejection from the nozzles, or an aperture plate may be used, as shown in FIG. 2.

To improve efficiency of the fluid ejector, in some embodiments the body of the ejector is made from materials that provide for a stable and reasonably hard (rigid) body. In other words, the nozzle-bearing body may be rigid. It is preferable to make the surfaces of the body reasonably smooth (i.e., substantially non-abrasive) so as to allow the gas supply head, and in particular, the ejectant supply assembly and the barrier fluid supply assembly to slide in relation to the body without being excessively worn away, and also provide for a seal without excessive gas leakage. In general, the smoother the surface of the body is the better the seal is, and thus the more efficient is the ejector.

It is also preferable to use corrosion-stable materials (i.e., stable to oxidation and degradation) to manufacture the components of the ejector, and in particular to manufacture the body of the ejector. What materials are used however may depend, for example, on the intended use of the ejector, such as the nature of the ejectant and volumes to be ejected by the ejector.

If the ejector employs a pulsatile gas supply to supply pressurised gas to the gas supply head, in some embodiments, the gas supply head has small inner dimensions and is preferably stiff (in the sense of having very low volumetric compliance). This may be achieved by using materials having a high Young's modulus, e.g., metals, glasses, ceramics, and carbon fibre composites, to manufacture the gas supply head.

The described ejectors enable dispensing of discrete quantities of ejectant onto a substrate, web, or other suitable surface. In some embodiments, a gap is maintained between the body of the ejector and the substrate (web, or other suitable surface) onto which the ejectant is to be deposited. Therefore, droplet(s) of the ejectant ejected from the respective nozzle(s) of the body traverse the gap (such as an air gap) before being deposited onto the substrate (web, or other suitable surface).

Such a separation gap ensures no contact between the body and the substrate, thereby (i) avoiding wear in use of the second surface of the body that otherwise may arise by such contact, (ii) allows the deposition of ejectant upon delicate substrates (such as cotton) or lightweight substrates (such as fabric gauze) or weak or brittle substrates (such as thin semiconductor wafers of silicon, gallium arsenide or other semiconductor), and/or (iii) allows serial deposition of discrete quantities of ejectants without the need for the prior drying or curing of the previous deposited quantity. This latter benefit accrues whether each subsequent deposited quantity is formed of the same or different ejectant material as prior-deposited quantities, and whether each subsequent deposited quantity is deposited directly onto the previous deposited quantity or onto some other region of the substrate.

As described herein, a fluid ejector can have multiple nozzles. In some example embodiments the multiple nozzles are formed within the body in a fixed pattern, or ‘nozzle template’. A nozzle template allows deposition of discrete quantities of ejectant onto substrates in a fixed pattern corresponding to the pattern of nozzles in the template. This provides a simple means by which complex patterns of ejectant can easily be deposited. For example, a curved or shaped pattern of ejectant can be deposited upon the substrate using a corresponding fixed nozzle template.

In some embodiments, the fluid ejector has a body having only a single nozzle formed therein. A single nozzle embodiment is particularly useful and advantageous, for example, in the case of compact industrial equipment, in which only individual ‘dots’ of ejectant need to be deposited upon a substrate at various controllable locations.

Although embodiments of the present disclosure have been described in the context of a fluid ejector comprising a nozzle-bearing body, an ejectant supply assembly, and a gas supply assembly, the principles of the present disclosure may be applied to other types of nozzle-based fluid ejector in which an ejectant is loaded into one or more nozzles and ejected from the nozzle(s) by an ejection force. As such, embodiments of the present disclosure are not limited to application to Powerdrop® apparatuses and may be applied to other nozzle-based fluid ejectors.

The apparatuses and methods disclosed herein may be used in a wide range of practical applications and industrial fields. Examples of such applications include:
a. food manufacturing or processing (e.g., depositing at least one food ingredient (e.g. a flavouring) onto edible substrates);
b. depositing a coating onto a substrate (e.g. food packaging manufacturing, furniture manufacturing, manufacture of road vehicles or components thereof, manufacture of marine vehicles or components thereof, etc.);
c. agrotechnology (e.g., ejection of agricultural chemicals);
d. biotechnology (e.g., ejection of biological materials);
e. electronics (e.g. manufacture of electronics components);
f. spray drying.

The ejectant may therefore comprise one or more of:
a. a food ingredient (e.g. flavouring);
b. a coating material (e.g. for food packaging, furniture, road vehicles or components thereof, marine vehicles or components thereof, etc.);
c. a chemical for agricultural use;
d. biological material;
e. a material used in the manufacture of electronics.

### Reference Example 1

A fluid ejector apparatus similar to that shown in FIG. 5 was used to apply an ejectant to a substrate. The ejectant was a water-based (i.e. aqueous) acrylic emulsion coating material. The drum had 0.7 mm diameter nozzles arranged in a hexagonal pattern with 2 mm centre-to-centre spacing. The drum had a 100.3 mm outside diameter, 182 rows of nozzles and 6 nozzles per row.

The apparatus was operated according to the following parameters:

| | |
|---|---|
| Drum surface speed [m/s] | 0.66 |
| Pressurised gas pressure [bar] | 2 |
| Aqueous material input flow rate [g/s] | 0.28 |

The apparatus was operated for 23 minutes and then assessed for nozzle clogging and dry residue formation on the surface of the drum,

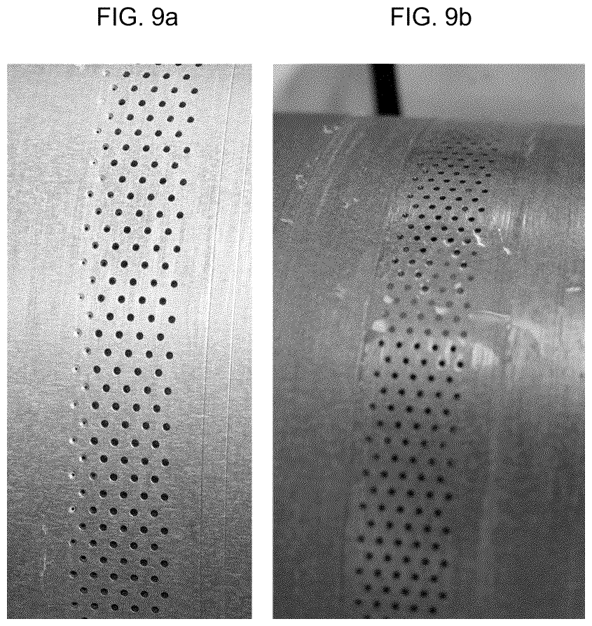

Nozzle clogging was observed (see FIG. 9a), and a layer of dried aqueous material formed on the surface of the drum (see FIG. 9b).

### Reference Example 2

The apparatus was operated as per Reference Example 1, but the ejectant was diluted with water in a ratio (by weight) of 20% water 80% ejectant and the diluted ejectant supplied to the ejectant supply assembly.

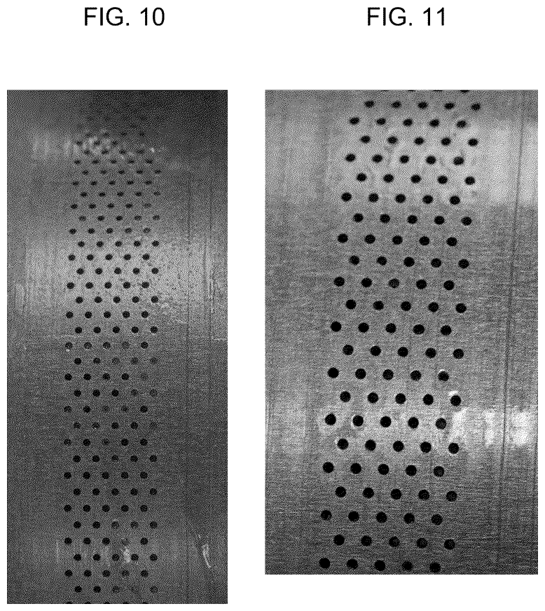

After 23 minutes of operation the nozzles were once again observed to be clogged and a film of dry ejectant residue was observed on the surface of the drum (see FIG. 10)

### Example 1

The apparatus was operated as per Reference Example 1, but water was additionally supplied to a barrier fluid supply apparatus at an input flow rate of 0.0585 g/s (i.e. in an amount of 17% by weight relative to the total amount by weight of the ejectant and the barrier fluid supplied to the ejectant supply assembly) to pre-load each of the nozzles with water prior to supplying the ejectant to the nozzle.

After 23 minutes the nozzles were observed to be clear and the surface of the drum was observed to be clean (see FIG. 11), thus demonstrating that supplying the water as a barrier fluid prior to supplying the ejectant is more effective at keeping the nozzles and the surface of the drum clean than simply diluting the ejectant with water, as in Reference Example 2.

1. A method for ejecting discrete volumes of ejectant, the method comprising:
supplying barrier fluid to each of one or more nozzles via a supply orifice of each of the one or more nozzles, wherein each of the one or more nozzles is formed in a body and is defined by a conduit extending through the body to connect a first orifice of the nozzle formed in a first surface of the body and a second orifice of the nozzle formed in a second surface of the body opposed to the first surface, and wherein the supply orifice is the first orifice or the second orifice of the nozzle; then
supplying ejectant to each of the one or more nozzles via the second orifice of each of the one or more nozzles; then
ejecting at least some of the ejectant from each of the one or more nozzles via the second orifice of each of the one or more nozzles;
wherein the barrier fluid at least partially coats an interior surface of each of the one or more nozzles to reduce contact of the ejectant with the interior surface of each of the one or more nozzles.

2. The method of claim 1, wherein ejecting at least some of the ejectant from each of the one or more nozzles via the second orifice of each of the one or more nozzles comprises ejecting at least some of the barrier fluid from each of the one or more nozzles via the second orifice of each of the one or more nozzles.

3. The method of claim 1 or claim 2, wherein the barrier fluid at least partially coats the interior surface of each of the one or more nozzles to reduce adhesion of the ejectant to the interior surface of each of the one or more nozzles.

4. The method of any preceding claim, wherein the barrier fluid at least partially coats the interior surface of each of the one or more nozzles, thereby lubricating the interface between the ejectant and the interior surface of the one or more nozzles to facilitate ejection of the ejectant from the one or more nozzles.

5. The method of any preceding claim, wherein supplying the barrier fluid to each of the one or more nozzles comprises moving the body relative to a barrier fluid supplier to expose the supply orifice of each of the one or more nozzles formed in the body to a barrier fluid supplier to supply the barrier fluid to each of the one or more nozzles via the supply orifice of each of the one or more nozzles.

6. The method of any preceding claim, wherein supplying the ejectant to each of the one or more nozzles via the second orifice of each of the one or more nozzles comprises moving the body relative to an ejectant supplier to expose the second orifice of each of the one or more nozzles to the ejectant supplier to supply the ejectant to each of the one or more nozzles via the second orifice of each of the one or more nozzles.

7. The method of any preceding claim, wherein ejecting at least some of the ejectant from each of the one or more nozzles via the second orifice of each of the one or more nozzles comprises supplying pressurised gas to each of the one or more nozzles via the first orifice of each of the one or more nozzles to cause ejection of the at least some of the ejectant from each of the one or more nozzles via the second orifice of each of the one or more nozzles.

8. The method of claim 7, wherein ejecting at least some of the ejectant from each of the one or more nozzles via the second orifice of each of the one or more nozzles comprises exposing the first orifice of each of the one or more nozzles to a gas supplier to supply the pressurised gas to each of the one or more nozzles via the first orifice of each of the one or more nozzles to cause ejection of the at least some of the ejectant from each of the one or more nozzles via the second orifice of each of the one or more nozzles.

9. The method of claim 8, wherein exposing the first orifice of each of the one or more nozzles to the gas supplier comprises moving the body relative to the gas supplier to expose the first orifice of each of the one or more nozzles to the gas supplier.

10. The method of any preceding claim, wherein the at least some of the ejectant is ejected from each of the one or more nozzles via the second orifice of each of the one or more nozzles onto a substrate.

11. The method of claim 10, further comprising:
continuously repeating the supplying the barrier fluid, the supplying the ejectant, and the ejecting at least some of the ejectant steps to form a substantially continuous coating of ejectant on the substrate.

12. The method of any preceding claim, wherein the body is a rotatable drum and the relative movements of the body are caused by rotation of the rotatable drum, optionally wherein the first surface of the body is the inside surface of the drum and the second surface of the drum is the outside surface of the drum.

13. The method of any preceding claim, wherein the barrier fluid and the ejectant are miscible.

14. The method of any preceding claim, wherein the barrier fluid and the ejectant comprise one or more common components.

15. The method of claim 14, wherein the one or more common components are carrier components of the ejectant, optionally wherein each of the one or more carrier components is a solvent component or a continuous-phase component of the ejectant.

16. The method of claim 14 or 15, wherein the barrier fluid comprises the one or more common components in an amount of at least 70% by weight.

17. The method of any preceding claim, wherein the barrier fluid and the ejectant are both aqueous fluids.

18. The method of claim 17, wherein the ejectant comprises a polyvinyl acetate (PVA) glue.

19. The method of any preceding claim, wherein the barrier fluid comprises water in an amount of at least about 90% by weight.

20. The method of any one of claims 17 to 19, wherein the barrier fluid comprises a wetting agent.

21. The method of any one of claims 1 to 17, wherein the barrier fluid and the ejectant are both oil-based fluids.

22. The method of any one of claims 1 to 12, wherein the barrier fluid and the ejectant are substantially immiscible.

23. The method of claim 22, wherein the barrier fluid is an aqueous fluid and the ejectant is an oil-based fluid, or wherein the barrier fluid is an oil-based fluid and the ejectant is an aqueous fluid.

24. The method of any preceding claim, wherein the supply orifice is the second orifice, and wherein the step of supplying the barrier fluid to each of the one or more nozzles further comprises depositing barrier fluid onto the second surface of the body, thereby reducing adhesion of the ejectant to the second surface of the body.

25. The method of any preceding claim, wherein the barrier fluid is supplied to the one or more nozzles in an amount by weight of 5 to 40% relative to the total amount by weight of the ejectant and the barrier fluid supplied to the one or more nozzles.

26. The method of claim 25, wherein the barrier fluid is supplied to the one or more nozzles in an amount by weight of 10 to 30% relative to the total amount by weight of the ejectant and the barrier fluid supplied to the one or more nozzles.

27. A fluid ejector for ejecting discrete volumes of ejectant, the fluid ejector comprising:
a body having opposed first and second surfaces and at least one nozzle defined between the first and second surfaces, each of the at least one nozzle defined by a conduit extending through the body to connect a first orifice formed in the first surface of the body and a second orifice formed in the second surface of the body;
a barrier fluid supplier for supplying barrier fluid to each of one or more nozzles of the at least one nozzle via a supply orifice of each of the one or more nozzles, wherein the supply orifice is the first orifice or the second orifice of the nozzle, and wherein the body and the barrier fluid supplier are movable relative to each other;
an ejectant supplier for supplying ejectant to each of the one or more nozzles via the second orifice of each of the one or more nozzles, wherein the body and the ejectant supplier are movable relative to each other; and
an ejector for imparting an ejection force to ejectant contained within each of the one or more nozzles;
wherein, in use, the fluid ejector performs the following steps:
a barrier fluid supply step in which relative movement of the barrier fluid supplier and the body causes the supply orifice of each of the one or more nozzles to be exposed to the barrier fluid supplier to supply the barrier fluid to each of the one or more nozzles via the supply orifice of each of the one or more nozzles; then,
an ejectant supply step in which relative movement of the ejectant supplier and the body causes the second orifice of each of the one or more nozzles to be exposed to the ejectant supplier to supply the ejectant to each of the one or more nozzles via the second orifice of each of the one or more nozzles; then,
an ejection step in which the ejector imparts an ejection force to the ejectant contained within each of the one or more nozzles to cause ejection of at least some of the ejectant from each of the one or more nozzles via the second orifice of each of the one or more nozzles.

28. The fluid ejector of claim 27, wherein the ejector is configured to impart an ejection force to the barrier fluid contained within each of the one or more nozzles, and wherein, in use, the ejector imparts an ejection force to the barrier fluid contained within each of the one or more nozzles to cause ejection of at least some of the barrier fluid from each of the one or more nozzles via the second orifice of each of the one or more nozzles.

29. The fluid ejector of claim 27 or 28, wherein the ejector comprises a gas supplier for supplying pressurised gas to each of the one or more nozzles via the first orifice of each of the one or more nozzles, and wherein, in use, the first orifice of each of the one or more nozzles is exposed to the gas supplier to supply pressurised gas to each of the one or more nozzles via the first orifice of each of the one or more nozzles to cause ejection of the at least some of the ejectant from each of the one or more nozzles via the second orifice of each of the one or more nozzles.

30. The fluid ejector of claim 29, wherein the body and the gas supplier are movable relative to each other, and wherein, in use, relative movement of the gas supplier and the body causes the first orifice of each of the one or more nozzles to be exposed to the gas supplier to supply the pressurised gas to each of the one or more nozzles via the first orifice of each of the one or more nozzles to cause ejection of the at least some of the ejectant from each of the one or more nozzles via the second orifice of each of the one or more nozzles.

31. The fluid ejector of any one of claims 27 to 30, wherein, in use, the barrier fluid supplier contacts the surface of the body in which the supply orifice is formed to effect the supply of the barrier fluid to each of the one or more nozzles.

32. The fluid ejector of any one of claims 27 to 31, wherein, in use, the barrier fluid supplier contacts the surface of the body in which the supply orifice is formed to clean residue from the surface of the body in which the supply orifice is formed in the vicinity of each first orifice or second orifice of the one or more nozzles.

33. The fluid ejector of claim 32, wherein the supply orifice is the second orifice, and wherein the residue comprises the ejectant.

34. The fluid ejector of any one of claims 31 to 33, wherein a displacement of the barrier fluid supplier relative to the body is adjustable so that a pressure applied to the surface of the body in which the supply orifice is formed by the barrier fluid supplier when in use is adjustable to control the amount of barrier fluid supplied to each of the one or more nozzles.

35. The fluid ejector of any one of claims 27 to 34, wherein the barrier fluid supplier comprises a barrier fluid reservoir configured to, in use, supply the barrier fluid to the one or more nozzles.

36. The fluid ejector of claim 35, wherein the barrier fluid reservoir comprises an absorbent medium.

37. The fluid ejector of claim 36, wherein the absorbent medium is configured to absorb the barrier fluid and distribute the barrier fluid across a portion of a contact surface of the barrier fluid supplier that contacts the surface of the body in which the supply orifice is formed to effect supply of the barrier fluid to each of the one or more nozzles.

38. The fluid ejector of claim 36 or 37, wherein the absorbent medium comprises a sponge.

39. The fluid ejector of any one or claims 36 to 38, wherein, in use, the absorbent medium contacts the surface of the body in which the supply orifice is formed to effect the supply of the barrier fluid to each of the one or more nozzles.

40. The fluid ejector of any one of claims 36 to 38, wherein the barrier fluid supplier comprises a contact layer overlaying the absorbent medium, wherein, in use, the contact layer contacts the surface of the body in which the supply orifice is formed to effect the supply of the barrier fluid to the one or more nozzles.

41. The fluid ejector of claim 40, wherein the contact layer has a more uniform surface profile than the absorbent medium.

42. The fluid ejector of claim 40 or 41, wherein the contact layer facilitates a uniform supply of the barrier fluid to each of the one or more nozzles.

43. The fluid ejector of any one of claims 40 to 42, wherein the contact layer is formed from a porous material.

44. The fluid ejector of any one of claims 40 to 43, wherein the contact layer is formed from a fabric or a chamois.

45. The fluid ejector of any one of claims 27 to 35, wherein the barrier fluid supplier comprises a filler that is shaped to cooperate with the surface of the body in which the supply orifice is formed when in use to define a cavity that defines the barrier fluid reservoir.

46. The fluid ejector of claim 45, wherein the filler comprises a resilient member that, in use, contacts the surface of the body in which the supply orifice is formed to remove residue from the surface of the body in which the supply orifice is formed.

47. The fluid ejector of any one of claims 27 to 46, wherein, in use, the barrier fluid supplier is positioned relative to the body such that supply of the barrier fluid to each of the one or more nozzles is gravity assisted.

48. The fluid ejector of claim 47, wherein, in use, the barrier fluid supplier contacts an upward-facing portion of the surface of the body in which the supply orifice is formed.

49. The fluid ejector of any one of claims 35 to 48, wherein the barrier fluid supplier comprises a barrier fluid feed configured to supply barrier fluid to the barrier fluid reservoir, and wherein a flow rate of the barrier fluid feed is adjustable.

50. The fluid ejector of any one of claims 27 to 49 wherein, in use, the ejectant supplier contacts the second surface of the body to effect the supply of the ejectant to each of the one or more nozzles.

51. The fluid ejector of any one of claims 27 to 50, wherein the ejectant supplier comprises an ejectant reservoir configured to, in use, supply the ejectant to each of the one or more nozzles.

52. The fluid ejector of claim 51, wherein the ejectant supplier comprises a filler that is shaped to cooperate with the second surface of the body when in use to define a cavity that defines the ejectant reservoir.

53. The fluid ejector of claim 51 or 52, wherein the ejectant supplier comprises an ejectant feed configured to supply ejectant to the ejectant reservoir, and wherein a flow rate of the ejectant feed is adjustable.

54. The fluid ejector of any one of claims 27 to 53, wherein the body is a rotatable drum, wherein the relative movements are caused by rotation of the rotatable drum, and wherein the first surface of the body is the inside surface of the drum and the second surface of the drum is the outside surface of the drum.

55. The fluid ejector of any one of claims 27 to 54, wherein, in use, the supply of the barrier fluid to each of the one or more nozzles reduces adhesion of the ejectant to an interior surface of each of the one or more nozzles.

56. The fluid ejector of claim 55, wherein, in use, once the barrier fluid and the ejectant have been supplied to each of the one or more nozzles the barrier fluid at least partially coats the interior surface of each of the one or more nozzles, thereby reducing adhesion of the ejectant to the interior surface of each of the one or more nozzles.

57. The fluid ejector of any one of claims 27 to 56, wherein the supply orifice is the second orifice, and wherein, in use, the barrier fluid supplier deposits barrier fluid onto the second surface of the body, thereby reducing adhesion of the ejectant to the second surface of the body.

58. The fluid ejector of any one of claims 27 to 57, wherein the ejector is configured to impart the ejection force to the ejectant contained within each of the one or more nozzles to eject the ejectant onto a substrate.

59. The fluid ejector of claim 58, wherein, in use, the fluid ejector continuously repeats the barrier fluid supply step, the ejectant supply step, and the ejection step to form a substantially continuous coating of ejectant on the substrate.

60. A barrier fluid supplier for a fluid ejector as defined in any one of claims 27 to 59.
